(19) United States
(12) Patent Application Publication
(10) Pub. No.: US 2013/0278771 A1
(43) Pub. Date: Oct. 24, 2013

(54) SYSTEMS AND METHODS FOR MONITORING VEHICLE WHEEL ASSEMBLY

(71) Applicant: FLIR Systems, Inc., Wilsonville, OR (US)

(72) Inventors: Carleton M. Magoun, Santa Barbara, CA (US); Patrick B. Richardson, Santa Barbara, CA (US); David M. Risdall, Santa Barbara, CA (US); Shawn Jepson, Goleta, CA (US); Jay B. James, Santa Barbara, CA (US); John H. Distelzweig, Santa Barbara, CA (US); Nicholas Högasten, Santa Barbara, CA (US); Theodore R. Hoelter, Goleta, CA (US); Katrin Strandemar, Rimbo (SE)

(21) Appl. No.: 13/892,202

(22) Filed: May 10, 2013

Related U.S. Application Data
(63) Continuation-in-part of application No. PCT/US2012/041744, filed on Jun. 8, 2012.
Application No. PCT/US2012/041744 is a continuation-in-part of application No. PCT/US2012/041749, filed on Jun. 8, 2012.
Application No. PCT/US2012/041749 is a continuation-in-part of application No. PCT/US2012/041739, filed on Jun. 8, 2012.
(60) Provisional application No. 61/645,831, filed on May 11, 2012.
(60) Provisional application No. 61/656,889, filed on Jun. 7, 2012.
(60) Provisional application No. 61/545,056, filed on Oct. 7, 2011.
(60) Provisional application No. 61/495,873, filed on Jun. 10, 2011.
(60) Provisional application No. 61/495,879, filed on Jun. 10, 2011.
(60) Provisional application No. 61/495,888, filed on Jun. 10, 2011.
(60) Provisional application No. 61/545,056, filed on Oct. 7, 2011.
(60) Provisional application No. 61/495,873, filed on Jun. 10, 2011.
(60) Provisional application No. 61/495,879, filed on Jun. 10, 2011.
(60) Provisional application No. 61/495,873, filed on Jun. 10, 2011.
(60) Provisional application No. 61/495,879, filed on Jun. 10, 2011.
(60) Provisional application No. 61/495,888, filed on Jun. 10, 2011.

(51) Int. Cl. H04N 5/33

(52) U.S. Cl. CPC H04N 5/33
USPC 348/148

(57) ABSTRACT

Various techniques are disclosed for systems and methods using small form factor infrared imaging modules to monitor various components of a vehicle wheel assembly. For example, a vehicle-mounted system may include one or more infrared imaging modules, a processor, a memory, a display, a communication module, and a vehicle speed sensor. The vehicle-mounted system may be mounted on, installed in, or otherwise integrated into a vehicle that has one or more wheel assemblies. The one or more infrared imaging modules may be configured to capture thermal images of desired portions of the wheel assemblies. Various thermal image analytics and profiling may be performed on the captured thermal images to determine the operating condition of various components of the wheel assemblies and to detect abnormalities. Monitoring information may be generated based on the detected condition and abnormalities, and presented to a driver or other occupants onboard the vehicle in real time.

### CROSS-REFERENCE TO RELATED APPLICATIONS

This patent application claims priority to and the benefit of U.S. Provisional Patent Application No. 61/645,831 filed May 11, 2012, which is incorporated herein by reference in its entirety.

This patent application is a continuation-in-part of International Patent Application No. PCT/US2012/041744 filed Jun. 8, 2012, which claims priority to and the benefit of U.S. Provisional Patent Application No. 61/656,889 filed Jun. 7, 2012 and entitled “LOW POWER AND SMALL FORM FACTOR INFRARED IMAGING,” which are incorporated herein by reference in their entirety.

International Patent Application No. PCT/US2012/041744 claims priority to and the benefit of U.S. Provisional Patent Application No. 61/545,056 filed Oct. 7, 2011 and entitled “NON-UNIFORMITY CORRECTION TECHNIQUES FOR INFRARED IMAGING DEVICES,” which are incorporated herein by reference in their entirety.

International Patent Application No. PCT/US2012/041744 claims priority to and the benefit of U.S. Provisional Patent Application No. 61/495,873 filed Jun. 10, 2011 and entitled “INFRARED CAMERA PACKAGING SYSTEMS AND METHODS,” which are incorporated herein by reference in their entirety.

International Patent Application No. PCT/US2012/041744 claims priority to and the benefit of U.S. Provisional Patent Application No. 61/495,879 filed Jun. 10, 2011 and entitled “INFRARED CAMERA SYSTEM ARCHITECTURES,” which are incorporated herein by reference in their entirety.

International Patent Application No. PCT/US2012/041744 claims priority to and the benefit of U.S. Provisional Patent Application No. 61/495,888 filed Jun. 10, 2011 and entitled “INFRARED CAMERA CALIBRATION TECHNIQUES,” which are incorporated herein by reference in their entirety.

This patent application is a continuation-in-part of International Patent Application No. PCT/US2012/041749 filed Jun. 8, 2012 and entitled “NON-UNIFORMITY CORRECTION TECHNIQUES FOR INFRARED IMAGING DEVICES,” which are incorporated herein by reference in their entirety.

International Patent Application No. PCT/US2012/041749 claims priority to and the benefit of U.S. Provisional Patent Application No. 61/545,056 filed Oct. 7, 2011 and entitled “NON-UNIFORMITY CORRECTION TECHNIQUES FOR INFRARED IMAGING DEVICES,” which are incorporated herein by reference in their entirety.

International Patent Application No. PCT/US2012/041749 claims priority to and the benefit of U.S. Provisional Patent Application No. 61/495,873 filed Jun. 10, 2011 and entitled “INFRARED CAMERA PACKAGING SYSTEMS AND METHODS,” which are incorporated herein by reference in their entirety.

International Patent Application No. PCT/US2012/041749 claims priority to and the benefit of U.S. Provisional Patent Application No. 61/495,879 filed Jun. 10, 2011 and entitled “INFRARED CAMERA SYSTEM ARCHITECTURES,” which are incorporated herein by reference in their entirety.

International Patent Application No. PCT/US2012/041749 claims priority to and the benefit of U.S. Provisional Patent Application No. 61/495,888 filed Jun. 10, 2011 and entitled “INFRARED CAMERA CALIBRATION TECHNIQUES,” which are incorporated herein by reference in their entirety.

This patent application is a continuation-in-part of International Patent Application No. PCT/US2012/041739 filed Jun. 8, 2012 and entitled “INFRARED CAMERA SYSTEM ARCHITECTURES,” which is hereby incorporated by reference in its entirety.

International Patent Application No. PCT/US2012/041739 claims priority to and the benefit of U.S. Provisional Patent Application No. 61/495,873 filed Jun. 10, 2011 and entitled “INFRARED CAMERA PACKAGING SYSTEMS AND METHODS,” which are incorporated herein by reference in their entirety.

International Patent Application No. PCT/US2012/041739 claims priority to and the benefit of U.S. Provisional Patent Application No. 61/495,879 filed Jun. 10, 2011 and entitled “INFRARED CAMERA SYSTEM ARCHITECTURES,” which are incorporated herein by reference in their entirety.

International Patent Application No. PCT/US2012/041739 claims priority to and the benefit of U.S. Provisional Patent Application No. 61/495,888 filed Jun. 10, 2011 and entitled “INFRARED CAMERA CALIBRATION TECHNIQUES,” which are incorporated herein by reference in their entirety.

### TECHNICAL FIELD

One or more embodiments of the invention relate generally to thermal imaging devices and more particularly, for example, to the use of thermal images to monitor vehicle wheel assembly components.

### BACKGROUND

The importance of monitoring the condition of vehicle wheel assembly components, such as tires, brakes, suspension links, hub bearings, and other components, cannot be overemphasized. Failure or degradation of vehicle wheel assembly components is a significant cause of vehicle accidents. In addition, improper maintenance of wheel assembly components can lead to costly premature wear even if not serious enough to cause an accident.

Conventionally, a tire pressure monitoring system (TPMS) aims to provide some monitoring of vehicle tires by detecting underinflation or overinflation. However, the effectiveness of a TPMS in providing an early warning of tire performance degradation or failure is questionable, since there are many other abnormal conditions undetectable by a TPMS that may directly lead to failure, performance degradation, or premature wear of tires. Furthermore, a TPMS monitors only tires, and not other types of wheel assembly components, such as brakes, suspension joints and links, hub bearings, or other components.

In another conventional approach, a conventional temperature sensor (e.g., a thermocouple or a thermometer) may be used to detect abnormally high temperatures in tires and/or detect the temperature difference between different tires or different sections of a tire. However, while such a sensor may crudely detect some temperature anomalies in tires, it cannot accurately detect and identify many other abnormal conditions (e.g., tire tread wear, structural weakness, slow air leak, layer separation, unbalanced tire, worn suspension components, or other conditions) that lead to failure, performance degradation, or premature wear of various components of a wheel assembly. Similarly, while brake temperature sensors have been installed in some aircraft landing gears to detect abnormally high brake temperature and/or to provide temperature readings, such sensors cannot accurately detect and identify many other abnormal conditions of a brake assembly.

While most of the undetectable abnormal conditions above may be detected through a visual and/or manual inspection on a stationary vehicle by a human expert, such an inspection is far from providing on-board, real-time, automatic monitoring and detection.

### SUMMARY

Various techniques are disclosed for systems and methods using small form factor infrared imaging modules to monitor various components of a vehicle wheel assembly. For example, a vehicle-mounted system may include one or more infrared imaging modules, a processor, a memory, a display, a communication module, and a vehicle speed sensor. The vehicle-mounted system may be mounted on, installed in, or otherwise integrated into a vehicle that has one or more wheel assemblies. The one or more infrared imaging modules may be configured to capture thermal images of desired portions of the wheel assemblies. Various thermal image analytics and profiling may be performed on the captured thermal images to determine the operating condition of various components of the wheel assemblies and to detect abnormalities. Monitoring information may be generated based on the detected condition and abnormalities, and presented to a driver or other occupants onboard the vehicle in real time.

In one embodiment, a vehicle includes a wheel assembly; an infrared imaging module comprising a focal plane array (FPA) configured to capture a thermal image of at least a portion the wheel assembly; and a processor in communication with the infrared imaging module and configured to process the thermal image to generate monitoring information associated with the wheel assembly.

In another embodiment, a method includes capturing, at a focal plane array (FPA) of an infrared imaging module, a thermal image of at least a portion of a wheel assembly of a vehicle, wherein the infrared imaging module is mounted in or on the vehicle so that the at least a portion of the wheel assembly is within its field of view (FOV); processing the thermal image to determine a condition of the wheel assembly; and generating monitoring information about the condition of the wheel assembly.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 illustrates an infrared imaging module configured to be implemented in a host device in accordance with an embodiment of the disclosure.

FIG. 2 illustrates an assembled infrared imaging module in accordance with an embodiment of the disclosure.

FIG. 3 illustrates an exploded view of an infrared imaging module juxtaposed over a socket in accordance with an embodiment of the disclosure.

FIG. 4 illustrates a block diagram of infrared sensor assembly including an array of infrared sensors in accordance with an embodiment of the disclosure.

FIG. 5 illustrates a flow diagram of various operations to determine NUC terms in accordance with an embodiment of the disclosure.

FIG. 6 illustrates differences between neighboring pixels in accordance with an embodiment of the disclosure.

FIG. 7 illustrates a flat field correction technique in accordance with an embodiment of the disclosure.

FIG. 8 illustrates various image processing techniques of FIG. 5 and other operations applied in an image processing pipeline in accordance with an embodiment of the disclosure.

FIG. 9 illustrates a temporal noise reduction process in accordance with an embodiment of the disclosure.

FIG. 10 illustrates particular implementation details of several processes of the image processing pipeline of FIG. 6 in accordance with an embodiment of the disclosure.

FIG. 11 illustrates spatially correlated FPN in a neighborhood of pixels in accordance with an embodiment of the disclosure.

FIG. 12 illustrates a block diagram of a vehicle-mounted system for monitoring components of a wheel assembly in accordance with an embodiment of the disclosure.

FIGS. 13A-13B illustrate various views of a vehicle having a vehicle-mounted system for monitoring components of a wheel assembly in accordance with an embodiment of the disclosure.

FIG. 13C illustrates an example thermal image of a tire tread that may be captured by an infrared imaging module in accordance with an embodiment of the disclosure.

FIG. 13D illustrates an example thermal image of various wheel assembly components that may be captured by an infrared imaging module in accordance with an embodiment of the disclosure.

FIG. 14 illustrates a vehicle dashboard having a display of the vehicle-mounted system in accordance with an embodiment of the disclosure.

FIG. 15 illustrates a process for on-board monitoring of wheel assembly components in accordance with an embodiment of the disclosure.

FIG. 16 illustrates an example thermal image of a tire showing a hot spot and a cold spot in accordance with an embodiment of the disclosure.

FIG. 17 illustrates an example thermal image of a brake rotor showing an uneven temperature distribution and variance pattern in accordance with an embodiment of the disclosure.

FIG. 18 illustrates several example thermal images of tires exhibiting various uneven temperature distribution and variance patterns in accordance with an embodiment of the disclosure.

Embodiments of the invention and their advantages are best understood by referring to the detailed description that follows. It should be appreciated that like reference numerals are used to identify like elements illustrated in one or more of the figures.

### DETAILED DESCRIPTION

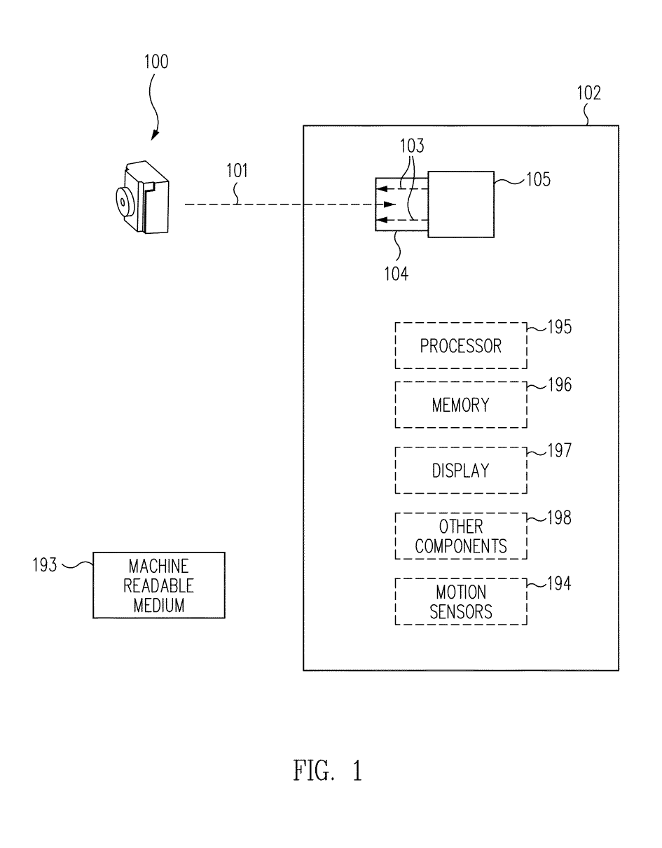

FIG. 1 illustrates an infrared imaging module 100 (e.g., an infrared camera or an infrared imaging device) configured to be implemented in a host device 102 in accordance with an embodiment of the disclosure. Infrared imaging module 100 may be implemented, for one or more embodiments, with a small form factor and in accordance with wafer level packaging techniques or other packaging techniques.

In one embodiment, infrared imaging module 100 may be configured to be implemented in a small portable host device 102, such as a mobile telephone, a tablet computing device, a laptop computing device, a personal digital assistant, a visible light camera, a music player, or any other appropriate mobile device. In this regard, infrared imaging module 100 may be used to provide infrared imaging features to host device 102. For example, infrared imaging module 100 may be configured to capture, process, and/or otherwise manage infrared images and provide such infrared images to host device 102 for use in any desired fashion (e.g., for further processing, to store in memory, to display, to use by various applications running on host device 102, to export to other devices, or other uses).

In various embodiments, infrared imaging module 100 may be configured to operate at low voltage levels and over a wide temperature range. For example, in one embodiment, infrared imaging module 100 may operate using a power supply of approximately 2.4 volts, 2.5 volts, 2.8 volts, or lower voltages, and operate over a temperature range of approximately −20 degrees C. to approximately +60 degrees C. (e.g., providing a suitable dynamic range and performance over an environmental temperature range of approximately 80 degrees C.). In one embodiment, by operating infrared imaging module 100 at low voltage levels, infrared imaging module 100 may experience reduced amounts of self heating in comparison with other types of infrared imaging devices. As a result, infrared imaging module 100 may be operated with reduced measures to compensate for such self heating.

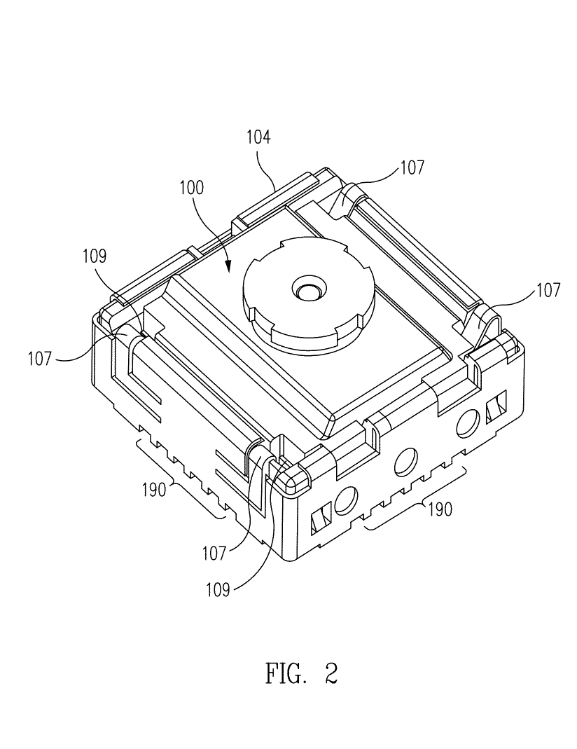

As shown in FIG. 1, host device 102 may include a socket 104, a shutter 105, motion sensors 194, a processor 195, a memory 196, a display 197, and/or other components 198. Socket 104 may be configured to receive infrared imaging module 100 as identified by arrow 101. In this regard, FIG. 2 illustrates infrared imaging module 100 assembled in socket 104 in accordance with an embodiment of the disclosure.

Motion sensors 194 may be implemented by one or more accelerometers, gyroscopes, or other appropriate devices that may be used to detect movement of host device 102. Motion sensors 194 may be monitored by and provide information to processing module 160 or processor 195 to detect motion. In various embodiments, motion sensors 194 may be implemented as part of host device 102 (as shown in FIG. 1), infrared imaging module 100, or other devices attached to or otherwise interfaced with host device 102.

Processor 195 may be implemented as any appropriate processing device (e.g., logic device, microcontroller, processor, application specific integrated circuit (ASIC), or other device) that may be used by host device 102 to execute appropriate instructions, such as software instructions provided in memory 196. Display 197 may be used to display captured and/or processed infrared images and/or other images, data, and information. Other components 198 may be used to implement any features of host device 102 as may be desired for various applications (e.g., clocks, temperature sensors, a visible light camera, or other components). In addition, a machine readable medium 193 may be provided for storing non-transitory instructions for loading into memory 196 and execution by processor 195.

In various embodiments, infrared imaging module 100 and socket 104 may be implemented for mass production to facilitate high volume applications, such as for implementation in mobile telephones or other devices (e.g., requiring small form factors). In one embodiment, the combination of infrared imaging module 100 and socket 104 may exhibit overall dimensions of approximately 8.5 mm by 8.5 mm by 5.9 mm while infrared imaging module 100 is installed in socket 104.

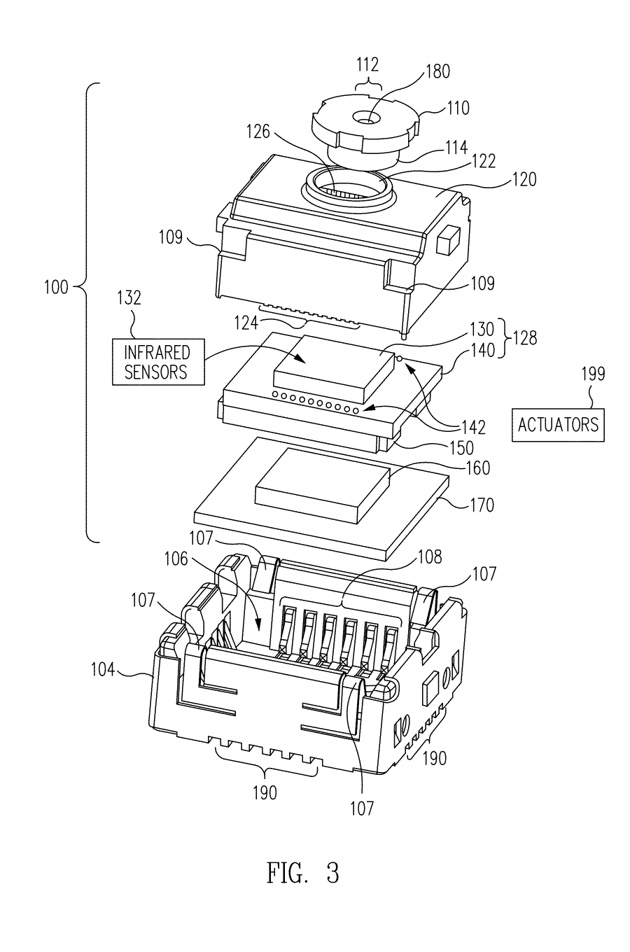

FIG. 3 illustrates an exploded view of infrared imaging module 100 juxtaposed over socket 104 in accordance with an embodiment of the disclosure. Infrared imaging module 100 may include a lens barrel 110, a housing 120, an infrared sensor assembly 128, a circuit board 170, a base 150, and a processing module 160.

Lens barrel 110 may at least partially enclose an optical element 180 (e.g., a lens) which is partially visible in FIG. 3 through an aperture 112 in lens barrel 110. Lens barrel 110 may include a substantially cylindrical extension 114 which may be used to interface lens barrel 110 with an aperture 122 in housing 120.

Infrared sensor assembly 128 may be implemented, for example, with a cap 130 (e.g., a lid) mounted on a substrate 140. Infrared sensor assembly 128 may include a plurality of infrared sensors 132 (e.g., infrared detectors) implemented in an array or other fashion on substrate 140 and covered by cap 130. For example, in one embodiment, infrared sensor assembly 128 may be implemented as a focal plane array (FPA). Such a focal plane array may be implemented, for example, as a vacuum package assembly (e.g., sealed by cap 130 and substrate 140). In one embodiment, infrared sensor assembly 128 may be implemented as a wafer level package (e.g., infrared sensor assembly 128 may be singulated from a set of vacuum package assemblies provided on a wafer). In one embodiment, infrared sensor assembly 128 may be implemented to operate using a power supply of approximately 2.4 volts, 2.5 volts, 2.8 volts, or similar voltages.

Infrared sensors 132 may be configured to detect infrared radiation (e.g., infrared energy) from a target scene including, for example, mid wave infrared wave bands (MWIR), long wave infrared wave bands (LWIR), and/or other thermal imaging bands as may be desired in particular implementations. In one embodiment, infrared sensor assembly 128 may be provided in accordance with wafer level packaging techniques.

Infrared sensors 132 may be implemented, for example, as microbolometers or other types of thermal imaging infrared sensors arranged in any desired array pattern to provide a plurality of pixels. In one embodiment, infrared sensors 132 may be implemented as vanadium oxide (VOx) detectors with a 17 μm pixel pitch. In various embodiments, arrays of approximately 32 by 32 infrared sensors 132, approximately 64 by 64 infrared sensors 132, approximately 80 by 64 infrared sensors 132, or other array sizes may be used.

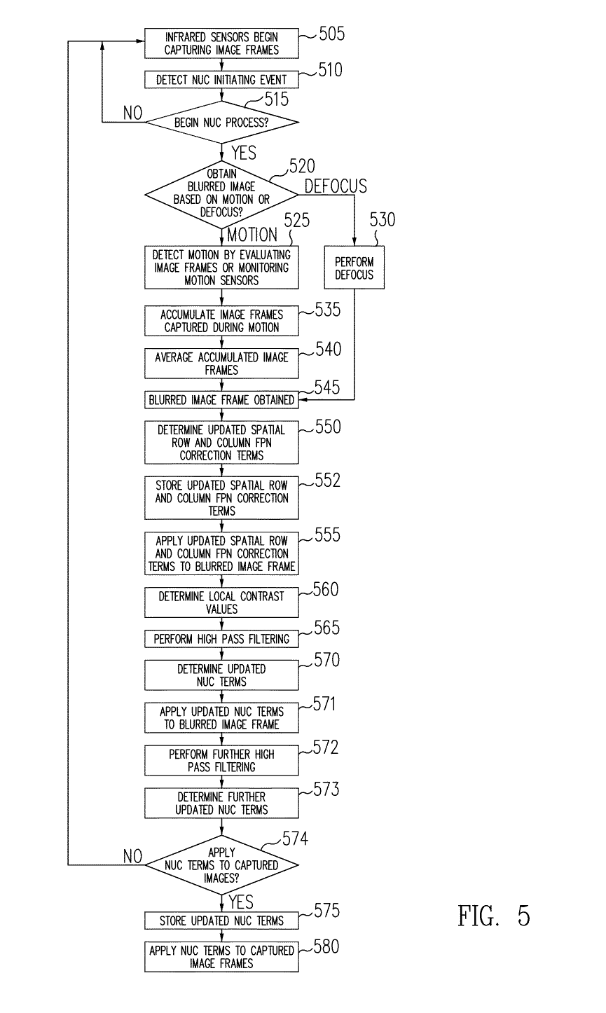

Substrate 140 may include various circuitry including, for example, a read out integrated circuit (ROIC) with dimensions less than approximately 5.5 mm by 5.5 mm in one embodiment. Substrate 140 may also include bond pads 142 that may be used to contact complementary connections positioned on inside surfaces of housing 120 when infrared imaging module 100 is assembled as shown in FIGS. 5A, 5B, and 5C. In one embodiment, the ROIC may be implemented with low-dropout regulators (LDO) to perform voltage regulation to reduce power supply noise introduced to infrared sensor assembly 128 and thus provide an improved power supply rejection ratio (PSRR). Moreover, by implementing the LDO with the ROIC (e.g., within a wafer level package), less die area may be consumed and fewer discrete die (or chips) are needed.

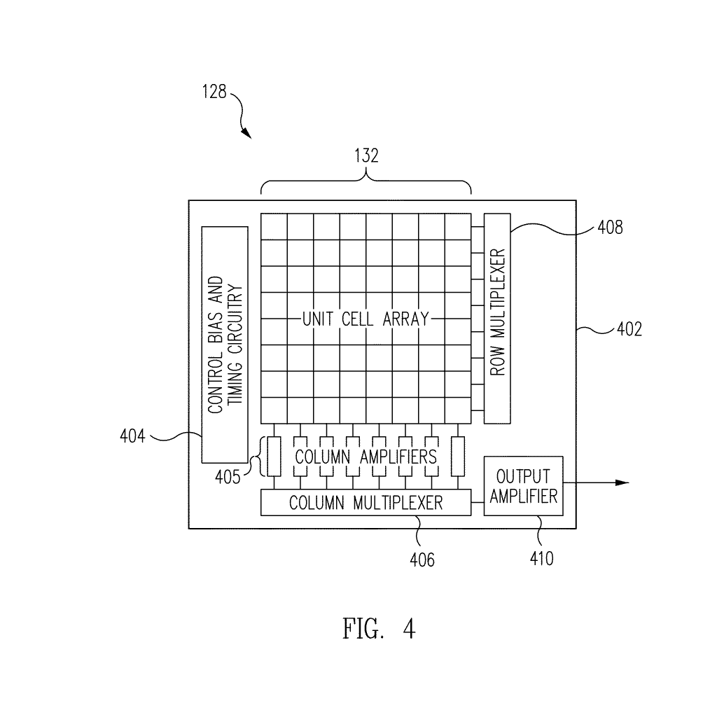

FIG. 4 illustrates a block diagram of infrared sensor assembly 128 including an array of infrared sensors 132 in accordance with an embodiment of the disclosure. In the illustrated embodiment, infrared sensors 132 are provided as part of a unit cell array of a ROIC 402. ROIC 402 includes bias generation and timing control circuitry 404, column amplifiers 405, a column multiplexer 406, a row multiplexer 408, and an output amplifier 410. Image frames (e.g., thermal images) captured by infrared sensors 132 may be provided by output amplifier 410 to processing module 160, processor 195, and/or any other appropriate components to perform various processing techniques described herein. Although an 8 by 8 array is shown in FIG. 4, any desired array configuration may be used in other embodiments. Further descriptions of ROICs and infrared sensors (e.g., microbolometer circuits) may be found in U.S. Pat. No. 6,028,309 issued Feb. 22, 2000, which is incorporated herein by reference in its entirety.

Infrared sensor assembly 128 may capture images (e.g., image frames) and provide such images from its ROIC at various rates. Processing module 160 may be used to perform appropriate processing of captured infrared images and may be implemented in accordance with any appropriate architecture. In one embodiment, processing module 160 may be implemented as an ASIC. In this regard, such an ASIC may be configured to perform image processing with high performance and/or high efficiency. In another embodiment, processing module 160 may be implemented with a general purpose central processing unit (CPU) which may be configured to execute appropriate software instructions to perform image processing, coordinate and perform image processing with various image processing blocks, coordinate interfacing between processing module 160 and host device 102, and/or other operations. In yet another embodiment, processing module 160 may be implemented with a field programmable gate array (FPGA). Processing module 160 may be implemented with other types of processing and/or logic circuits in other embodiments as would be understood by one skilled in the art.

In these and other embodiments, processing module 160 may also be implemented with other components where appropriate, such as, volatile memory, non-volatile memory, and/or one or more interfaces (e.g., infrared detector interfaces, inter-integrated circuit (I2C) interfaces, mobile industry processor interfaces (MIPI), joint test action group (JTAG) interfaces (e.g., IEEE 1149.1 standard test access port and boundary-scan architecture), and/or other interfaces).

In some embodiments, infrared imaging module 100 may further include one or more actuators 199 which may be used to adjust the focus of infrared image frames captured by infrared sensor assembly 128. For example, actuators 199 may be used to move optical element 180, infrared sensors 132, and/or other components relative to each other to selectively focus and defocus infrared image frames in accordance with techniques described herein. Actuators 199 may be implemented in accordance with any type of motion-inducing apparatus or mechanism, and may positioned at any location within or external to infrared imaging module 100 as appropriate for different applications.

When infrared imaging module 100 is assembled, housing 120 may substantially enclose infrared sensor assembly 128, base 150, and processing module 160. Housing 120 may facilitate connection of various components of infrared imaging module 100. For example, in one embodiment, housing 120 may provide electrical connections 126 to connect various components as further described.

Electrical connections 126 (e.g., conductive electrical paths, traces, or other types of connections) may be electrically connected with bond pads 142 when infrared imaging module 100 is assembled. In various embodiments, electrical connections 126 may be embedded in housing 120, provided on inside surfaces of housing 120, and/or otherwise provided by housing 120. Electrical connections 126 may terminate in connections 124 protruding from the bottom surface of housing 120 as shown in FIG. 3. Connections 124 may connect with circuit board 170 when infrared imaging module 100 is assembled (e.g., housing 120 may rest atop circuit board 170 in various embodiments). Processing module 160 may be electrically connected with circuit board 170 through appropriate electrical connections. As a result, infrared sensor assembly 128 may be electrically connected with processing module 160 through, for example, conductive electrical paths provided by: bond pads 142, complementary connections on inside surfaces of housing 120, electrical connections 126 of housing 120, connections 124, and circuit board 170. Advantageously, such an arrangement may be implemented without requiring wire bonds to be provided between infrared sensor assembly 128 and processing module 160.

In various embodiments, electrical connections 126 in housing 120 may be made from any desired material (e.g., copper or any other appropriate conductive material). In one embodiment, electrical connections 126 may aid in dissipating heat from infrared imaging module 100.

Other connections may be used in other embodiments. For example, in one embodiment, sensor assembly 128 may be attached to processing module 160 through a ceramic board that connects to sensor assembly 128 by wire bonds and to processing module 160 by a ball grid array (BGA). In another embodiment, sensor assembly 128 may be mounted directly on a rigid flexible board and electrically connected with wire bonds, and processing module 160 may be mounted and connected to the rigid flexible board with wire bonds or a BGA.

The various implementations of infrared imaging module 100 and host device 102 set forth herein are provided for purposes of example, rather than limitation. In this regard, any of the various techniques described herein may be applied to any infrared camera system, infrared imager, or other device for performing infrared/thermal imaging.

Substrate 140 of infrared sensor assembly 128 may be mounted on base 150. In various embodiments, base 150 (e.g., a pedestal) may be made, for example, of copper formed by metal injection molding (MIM) and provided with a black oxide or nickel-coated finish. In various embodiments, base 150 may be made of any desired material, such as for example zinc, aluminum, or magnesium, as desired for a given application and may be formed by any desired applicable process, such as for example aluminum casting, MIM, or zinc rapid casting, as may be desired for particular applications. In various embodiments, base 150 may be implemented to provide structural support, various circuit paths, thermal heat sink properties, and other features where appropriate. In one embodiment, base 150 may be a multi-layer structure implemented at least in part using ceramic material.

In various embodiments, circuit board 170 may receive housing 120 and thus may physically support the various components of infrared imaging module 100. In various embodiments, circuit board 170 may be implemented as a printed circuit board (e.g., an FR4 circuit board or other types of circuit boards), a rigid or flexible interconnect (e.g., tape or other type of interconnects), a flexible circuit substrate, a flexible plastic substrate, or other appropriate structures. In various embodiments, base 150 may be implemented with the various features and attributes described for circuit board 170, and vice versa.

Socket 104 may include a cavity 106 configured to receive infrared imaging module 100 (e.g., as shown in the assembled view of FIG. 2). Infrared imaging module 100 and/or socket 104 may include appropriate tabs, arms, pins, fasteners, or any other appropriate engagement members which may be used to secure infrared imaging module 100 to or within socket 104 using friction, tension, adhesion, and/or any other appropriate manner. Socket 104 may include engagement members 107 that may engage surfaces 109 of housing 120 when infrared imaging module 100 is inserted into a cavity 106 of socket 104. Other types of engagement members may be used in other embodiments.

Infrared imaging module 100 may be electrically connected with socket 104 through appropriate electrical connections (e.g., contacts, pins, wires, or any other appropriate connections). For example, socket 104 may include electrical connections 108 which may contact corresponding electrical connections of infrared imaging module 100 (e.g., interconnect pads, contacts, or other electrical connections on side or bottom surfaces of circuit board 170, bond pads 142 or other electrical connections on base 150, or other connections). Electrical connections 108 may be made from any desired material (e.g., copper or any other appropriate conductive material). In one embodiment, electrical connections 108 may be mechanically biased to press against electrical connections of infrared imaging module 100 when infrared imaging module 100 is inserted into cavity 106 of socket 104. In one embodiment, electrical connections 108 may at least partially secure infrared imaging module 100 in socket 104. Other types of electrical connections may be used in other embodiments.

Socket 104 may be electrically connected with host device 102 through similar types of electrical connections. For example, in one embodiment, host device 102 may include electrical connections (e.g., soldered connections, snap-in connections, or other connections) that connect with electrical connections 108 passing through apertures 190. In various embodiments, such electrical connections may be made to the sides and/or bottom of socket 104.

Various components of infrared imaging module 100 may be implemented with flip chip technology which may be used to mount components directly to circuit boards without the additional clearances typically needed for wire bond connections. Flip chip connections may be used, as an example, to reduce the overall size of infrared imaging module 100 for use in compact small form factor applications. For example, in one embodiment, processing module 160 may be mounted to circuit board 170 using flip chip connections. For example, infrared imaging module 100 may be implemented with such flip chip configurations.

In various embodiments, infrared imaging module 100 and/or associated components may be implemented in accordance with various techniques (e.g., wafer level packaging techniques) as set forth in U.S. patent application Ser. No. 12/844,124 filed Jul. 27, 2010, and U.S. Provisional Patent Application No. 61/469,651 filed Mar. 30, 2011, which are incorporated herein by reference in their entirety. Furthermore, in accordance with one or more embodiments, infrared imaging module 100 and/or associated components may be implemented, calibrated, tested, and/or used in accordance with various techniques, such as for example as set forth in U.S. Pat. No. 7,470,902 issued Dec. 30, 2008, U.S. Pat. No. 6,028,309 issued Feb. 22, 2000, U.S. Pat. No. 6,812,465 issued Nov. 2, 2004, U.S. Pat. No. 7,034,301 issued Apr. 25, 2006, U.S. Pat. No. 7,679,048 issued Mar. 16, 2010, U.S. Pat. No. 7,470,904 issued Dec. 30, 2008, U.S. patent application Ser. No. 12/202,880 filed Sep. 2, 2008, and U.S. patent application Ser. No. 12/202,896 filed Sep. 2, 2008, which are incorporated herein by reference in their entirety.

Referring again to FIG. 1, in various embodiments, host device 102 may include shutter 105. In this regard, shutter 105 may be selectively positioned over socket 104 (e.g., as identified by arrows 103) while infrared imaging module 100 is installed therein. In this regard, shutter 105 may be used, for example, to protect infrared imaging module 100 when not in use. Shutter 105 may also be used as a temperature reference as part of a calibration process (e.g., a NUC process or other calibration processes) for infrared imaging module 100 as would be understood by one skilled in the art.

In various embodiments, shutter 105 may be made from various materials such as, for example, polymers, glass, aluminum (e.g., painted or anodized) or other materials. In various embodiments, shutter 105 may include one or more coatings to selectively filter electromagnetic radiation and/or adjust various optical properties of shutter 105 (e.g., a uniform blackbody coating or a reflective gold coating).

In another embodiment, shutter 105 may be fixed in place to protect infrared imaging module 100 at all times. In this case, shutter 105 or a portion of shutter 105 may be made from appropriate materials (e.g., polymers or infrared transmitting materials such as silicon, germanium, zinc selenide, or chalcogenide glasses) that do not substantially filter desired infrared wavelengths. In another embodiment, a shutter may be implemented as part of infrared imaging module 100 (e.g., within or as part of a lens barrel or other components of infrared imaging module 100), as would be understood by one skilled in the art.

Alternatively, in another embodiment, a shutter (e.g., shutter 105 or other type of external or internal shutter) need not be provided, but rather a NUC process or other type of calibration may be performed using shutterless techniques. In another embodiment, a NUC process or other type of calibration using shutterless techniques may be performed in combination with shutter-based techniques.

Infrared imaging module 100 and host device 102 may be implemented in accordance with any of the various techniques set forth in U.S. Provisional Patent Application No. 61/495,873 filed Jun. 10, 2011, U.S. Provisional Patent Application No. 61/495,879 filed Jun. 10, 2011, and U.S. Provisional Patent Application No. 61/495,888 filed Jun. 10, 2011, which are incorporated herein by reference in their entirety.

In various embodiments, the components of host device 102 and/or infrared imaging module 100 may be implemented as a local or distributed system with components in communication with each other over wired and/or wireless networks. Accordingly, the various operations identified in this disclosure may be performed by local and/or remote components as may be desired in particular implementations.

FIG. 5 illustrates a flow diagram of various operations to determine NUC terms in accordance with an embodiment of the disclosure. In some embodiments, the operations of FIG. 5 may be performed by processing module 160 or processor 195 (both also generally referred to as a processor) operating on image frames captured by infrared sensors 132.

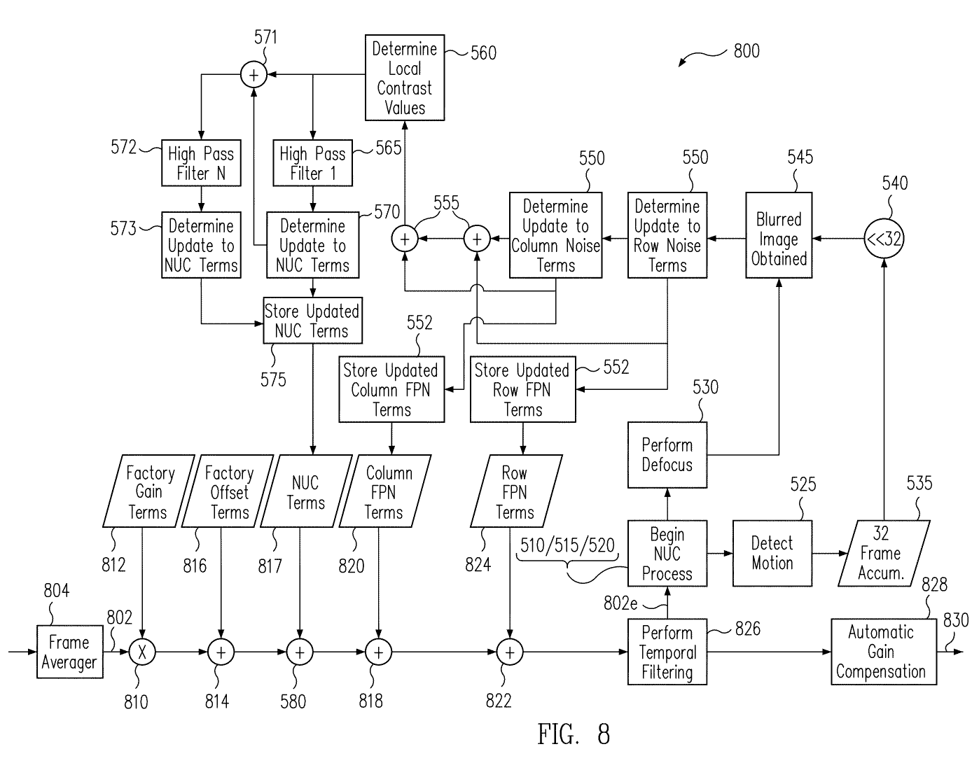

In block 505, infrared sensors 132 begin capturing image frames of a scene. Typically, the scene will be the real world environment in which host device 102 is currently located. In this regard, shutter 105 (if optionally provided) may be opened to permit infrared imaging module to receive infrared radiation from the scene. Infrared sensors 132 may continue capturing image frames during all operations shown in FIG. 5. In this regard, the continuously captured image frames may be used for various operations as further discussed. In one embodiment, the captured image frames may be temporally filtered (e.g., in accordance with the process of block 826 further described herein with regard to FIG. 8) and be processed by other terms (e.g., factory gain terms 812, factory offset terms 816, previously determined NUC terms 817, column FPN terms 820, and row FPN terms 824 as further described herein with regard to FIG. 8) before they are used in the operations shown in FIG. 5.

In block 510, a NUC process initiating event is detected. In one embodiment, the NUC process may be initiated in response to physical movement of host device 102. Such movement may be detected, for example, by motion sensors 194 which may be polled by a processor. In one example, a user may move host device 102 in a particular manner, such as by intentionally waving host device 102 back and forth in an “erase” or “swipe” movement. In this regard, the user may move host device 102 in accordance with a predetermined speed and direction (velocity), such as in an up and down, side to side, or other pattern to initiate the NUC process. In this example, the use of such movements may permit the user to intuitively operate host device 102 to simulate the “erasing” of noise in captured image frames.

In another example, a NUC process may be initiated by host device 102 if motion exceeding a threshold value is exceeded (e.g., motion greater than expected for ordinary use). It is contemplated that any desired type of spatial translation of host device 102 may be used to initiate the NUC process.

In yet another example, a NUC process may be initiated by host device 102 if a minimum time has elapsed since a previously performed NUC process. In a further example, a NUC process may be initiated by host device 102 if infrared imaging module 100 has experienced a minimum temperature change since a previously performed NUC process. In a still further example, a NUC process may be continuously initiated and repeated.

In block 515, after a NUC process initiating event is detected, it is determined whether the NUC process should actually be performed. In this regard, the NUC process may be selectively initiated based on whether one or more additional conditions are met. For example, in one embodiment, the NUC process may not be performed unless a minimum time has elapsed since a previously performed NUC process. In another embodiment, the NUC process may not be performed unless infrared imaging module 100 has experienced a minimum temperature change since a previously performed NUC process. Other criteria or conditions may be used in other embodiments. If appropriate criteria or conditions have been met, then the flow diagram continues to block 520. Otherwise, the flow diagram returns to block 505.

In the NUC process, blurred image frames may be used to determine NUC terms which may be applied to captured image frames to correct for FPN. As discussed, in one embodiment, the blurred image frames may be obtained by accumulating multiple image frames of a moving scene (e.g., captured while the scene and/or the thermal imager is in motion). In another embodiment, the blurred image frames may be obtained by defocusing an optical element or other component of the thermal imager.

Accordingly, in block 520 a choice of either approach is provided. If the motion-based approach is used, then the flow diagram continues to block 525. If the defocus-based approach is used, then the flow diagram continues to block 530.

Referring now to the motion-based approach, in block 525 motion is detected. For example, in one embodiment, motion may be detected based on the image frames captured by infrared sensors 132. In this regard, an appropriate motion detection process (e.g., an image registration process, a frame-to-frame difference calculation, or other appropriate process) may be applied to captured image frames to determine whether motion is present (e.g., whether static or moving image frames have been captured). For example, in one embodiment, it can be determined whether pixels or regions around the pixels of consecutive image frames have changed more than a user defined amount (e.g., a percentage and/or threshold value). If at least a given percentage of pixels have changed by at least the user defined amount, then motion will be detected with sufficient certainty to proceed to block 535.

In another embodiment, motion may be determined on a per pixel basis, wherein only pixels that exhibit significant changes are accumulated to provide the blurred image frame. For example, counters may be provided for each pixel and used to ensure that the same number of pixel values are accumulated for each pixel, or used to average the pixel values based on the number of pixel values actually accumulated for each pixel. Other types of image-based motion detection may be performed such as performing a Radon transform.

In another embodiment, motion may be detected based on data provided by motion sensors 194. In one embodiment, such motion detection may include detecting whether host device 102 is moving along a relatively straight trajectory through space. For example, if host device 102 is moving along a relatively straight trajectory, then it is possible that certain objects appearing in the imaged scene may not be sufficiently blurred (e.g., objects in the scene that may be aligned with or moving substantially parallel to the straight trajectory). Thus, in such an embodiment, the motion detected by motion sensors 194 may be conditioned on host device 102 exhibiting, or not exhibiting, particular trajectories.

In yet another embodiment, both a motion detection process and motion sensors 194 may be used. Thus, using any of these various embodiments, a determination can be made as to whether or not each image frame was captured while at least a portion of the scene and host device 102 were in motion relative to each other (e.g., which may be caused by host device 102 moving relative to the scene, at least a portion of the scene moving relative to host device 102, or both).

It is expected that the image frames for which motion was detected may exhibit some secondary blurring of the captured scene (e.g., blurred thermal image data associated with the scene) due to the thermal time constants of infrared sensors 132 (e.g., microbolometer thermal time constants) interacting with the scene movement.

In block 535, image frames for which motion was detected are accumulated. For example, if motion is detected for a continuous series of image frames, then the image frames of the series may be accumulated. As another example, if motion is detected for only some image frames, then the non-moving image frames may be skipped and not included in the accumulation. Thus, a continuous or discontinuous set of image frames may be selected to be accumulated based on the detected motion.

In block 540, the accumulated image frames are averaged to provide a blurred image frame. Because the accumulated image frames were captured during motion, it is expected that actual scene information will vary between the image frames and thus cause the scene information to be further blurred in the resulting blurred image frame (block 545).

In contrast, FPN (e.g., caused by one or more components of infrared imaging module 100) will remain fixed over at least short periods of time and over at least limited changes in scene irradiance during motion. As a result, image frames captured in close proximity in time and space during motion will suffer from identical or at least very similar FPN. Thus, although scene information may change in consecutive image frames, the FPN will stay essentially constant. By averaging, multiple image frames captured during motion will blur the scene information, but will not blur the FPN. As a result, FPN will remain more clearly defined in the blurred image frame provided in block 545 than the scene information.

In one embodiment, 32 or more image frames are accumulated and averaged in blocks 535 and 540. However, any desired number of image frames may be used in other embodiments, but with generally decreasing correction accuracy as frame count is decreased.

Referring now to the defocus-based approach, in block 530, a defocus operation may be performed to intentionally defocus the image frames captured by infrared sensors 132. For example, in one embodiment, one or more actuators 199 may be used to adjust, move, or otherwise translate optical element 180, infrared sensor assembly 128, and/or other components of infrared imaging module 100 to cause infrared sensors 132 to capture a blurred (e.g., unfocused) image frame of the scene. Other non-actuator based techniques are also contemplated for intentionally defocusing infrared image frames such as, for example, manual (e.g., user-initiated) defocusing.

Although the scene may appear blurred in the image frame, FPN (e.g., caused by one or more components of infrared imaging module 100) will remain unaffected by the defocusing operation. As a result, a blurred image frame of the scene will be provided (block 545) with FPN remaining more clearly defined in the blurred image than the scene information.

In the above discussion, the defocus-based approach has been described with regard to a single captured image frame. In another embodiment, the defocus-based approach may include accumulating multiple image frames while the infrared imaging module 100 has been defocused and averaging the defocused image frames to remove the effects of temporal noise and provide a blurred image frame in block 545.

Thus, it will be appreciated that a blurred image frame may be provided in block 545 by either the motion-based approach or the defocus-based approach. Because much of the scene information will be blurred by either motion, defocusing, or both, the blurred image frame may be effectively considered a low pass filtered version of the original captured image frames with respect to scene information.

In block 550, the blurred image frame is processed to determine updated row and column FPN terms (e.g., if row and column FPN terms have not been previously determined then the updated row and column FPN terms may be new row and column FPN terms in the first iteration of block 550). As used in this disclosure, the terms row and column may be used interchangeably depending on the orientation of infrared sensors 132 and/or other components of infrared imaging module 100.

In one embodiment, block 550 includes determining a spatial FPN correction term for each row of the blurred image frame (e.g., each row may have its own spatial FPN correction term), and also determining a spatial FPN correction term for each column of the blurred image frame (e.g., each column may have its own spatial FPN correction term). Such processing may be used to reduce the spatial and slowly varying (1/f) row and column FPN inherent in thermal imagers caused by, for example, 1/f noise characteristics of amplifiers in ROIC 402 which may manifest as vertical and horizontal stripes in image frames.

Advantageously, by determining spatial row and column FPN terms using the blurred image frame, there will be a reduced risk of vertical and horizontal objects in the actual imaged scene from being mistaken for row and column noise (e.g., real scene content will be blurred while FPN remains unblurred).

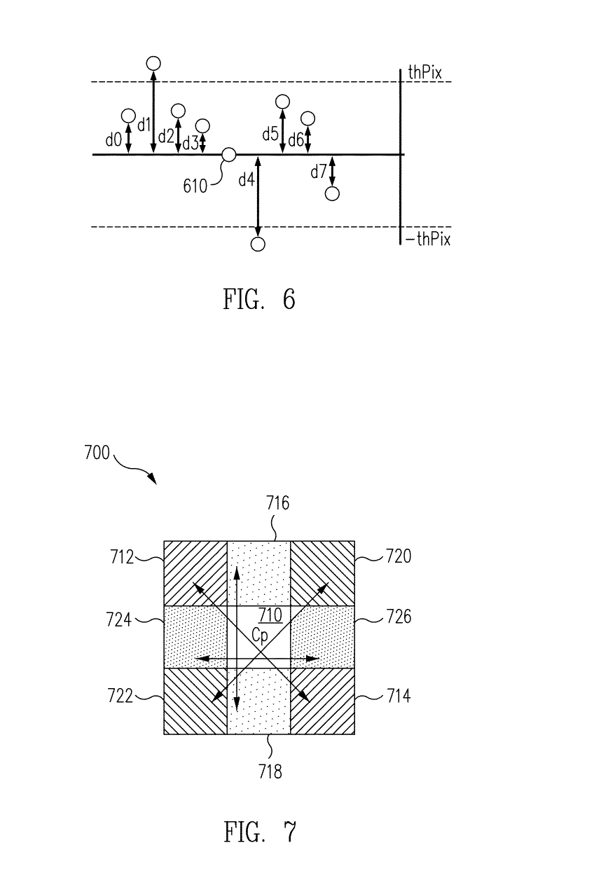

In one embodiment, row and column FPN terms may be determined by considering differences between neighboring pixels of the blurred image frame. For example, FIG. 6 illustrates differences between neighboring pixels in accordance with an embodiment of the disclosure. Specifically, in FIG. 6 a pixel 610 is compared to its 8 nearest horizontal neighbors: d0-d3 on one side and d4-d7 on the other side. Differences between the neighbor pixels can be averaged to obtain an estimate of the offset error of the illustrated group of pixels. An offset error may be calculated for each pixel in a row or column and the average result may be used to correct the entire row or column.

To prevent real scene data from being interpreted as noise, upper and lower threshold values may be used (thPix and −thPix). Pixel values falling outside these threshold values (pixels d1 and d4 in this example) are not used to obtain the offset error. In addition, the maximum amount of row and column FPN correction may be limited by these threshold values.

Further techniques for performing spatial row and column FPN correction processing are set forth in U.S. patent application Ser. No. 12/396,340 filed Mar. 2, 2009 which is incorporated herein by reference in its entirety.

Referring again to FIG. 5, the updated row and column FPN terms determined in block 550 are stored (block 552) and applied (block 555) to the blurred image frame provided in block 545. After these terms are applied, some of the spatial row and column FPN in the blurred image frame may be reduced. However, because such terms are applied generally to rows and columns, additional FPN may remain such as spatially uncorrelated FPN associated with pixel to pixel drift or other causes. Neighborhoods of spatially correlated FPN may also remain which may not be directly associated with individual rows and columns. Accordingly, further processing may be performed as discussed below to determine NUC terms.

In block 560, local contrast values (e.g., edges or absolute values of gradients between adjacent or small groups of pixels) in the blurred image frame are determined. If scene information in the blurred image frame includes contrasting areas that have not been significantly blurred (e.g., high contrast edges in the original scene data), then such features may be identified by a contrast determination process in block 560.

For example, local contrast values in the blurred image frame may be calculated, or any other desired type of edge detection process may be applied to identify certain pixels in the blurred image as being part of an area of local contrast. Pixels that are marked in this manner may be considered as containing excessive high spatial frequency scene information that would be interpreted as FPN (e.g., such regions may correspond to portions of the scene that have not been sufficiently blurred). As such, these pixels may be excluded from being used in the further determination of NUC terms. In one embodiment, such contrast detection processing may rely on a threshold that is higher than the expected contrast value associated with FPN (e.g., pixels exhibiting a contrast value higher than the threshold may be considered to be scene information, and those lower than the threshold may be considered to be exhibiting FPN).

In one embodiment, the contrast determination of block 560 may be performed on the blurred image frame after row and column FPN terms have been applied to the blurred image frame (e.g., as shown in FIG. 5). In another embodiment, block 560 may be performed prior to block 550 to determine contrast before row and column FPN terms are determined (e.g., to prevent scene based contrast from contributing to the determination of such terms).

Following block 560, it is expected that any high spatial frequency content remaining in the blurred image frame may be generally attributed to spatially uncorrelated FPN. In this regard, following block 560, much of the other noise or actual desired scene based information has been removed or excluded from the blurred image frame due to: intentional blurring of the image frame (e.g., by motion or defocusing in blocks 520 through 545), application of row and column FPN terms (block 555), and contrast determination of (block 560).

Thus, it can be expected that following block 560, any remaining high spatial frequency content (e.g., exhibited as areas of contrast or differences in the blurred image frame) may be attributed to spatially uncorrelated FPN. Accordingly, in block 565, the blurred image frame is high pass filtered. In one embodiment, this may include applying a high pass filter to extract the high spatial frequency content from the blurred image frame. In another embodiment, this may include applying a low pass filter to the blurred image frame and taking a difference between the low pass filtered image frame and the unfiltered blurred image frame to obtain the high spatial frequency content. In accordance with various embodiments of the present disclosure, a high pass filter may be implemented by calculating a mean difference between a sensor signal (e.g., a pixel value) and its neighbors.

In block 570, a flat field correction process is performed on the high pass filtered blurred image frame to determine updated NUC terms (e.g., if a NUC process has not previously been performed then the updated NUC terms may be new NUC terms in the first iteration of block 570).

For example, FIG. 7 illustrates a flat field correction technique 700 in accordance with an embodiment of the disclosure. In FIG. 7, a NUC term may be determined for each pixel 710 of the blurred image frame using the values of its neighboring pixels 712 to 726. For each pixel 710, several gradients may be determined based on the absolute difference between the values of various adjacent pixels. For example, absolute value differences may be determined between: pixels 712 and 714 (a left to right diagonal gradient), pixels 716 and 718 (a top to bottom vertical gradient), pixels 720 and 722 (a right to left diagonal gradient), and pixels 724 and 726 (a left to right horizontal gradient).

These absolute differences may be summed to provide a summed gradient for pixel 710. A weight value may be determined for pixel 710 that is inversely proportional to the summed gradient. This process may be performed for all pixels 710 of the blurred image frame until a weight value is provided for each pixel 710. For areas with low gradients (e.g., areas that are blurry or have low contrast), the weight value will be close to one. Conversely, for areas with high gradients, the weight value will be zero or close to zero. The update to the NUC term as estimated by the high pass filter is multiplied with the weight value.

In one embodiment, the risk of introducing scene information into the NUC terms can be further reduced by applying some amount of temporal damping to the NUC term determination process. For example, a temporal damping factor λ between 0 and 1 may be chosen such that the new NUC term (NUC_{NEW}) stored is a weighted average of the old NUC term (NUC_{OLD}) and the estimated updated NUC term (NUC_{UPDATE}). In one embodiment, this can be expressed as NUC_{NEW}=λ·NUC_{OLD} (1−λ)·(NUC_{OLD}+NUC_{UPDATE}).

Although the determination of NUC terms has been described with regard to gradients, local contrast values may be used instead where appropriate. Other techniques may also be used such as, for example, standard deviation calculations. Other types flat field correction processes may be performed to determine NUC terms including, for example, various processes identified in U.S. Pat. No. 6,028,309 issued Feb. 22, 2000, U.S. Pat. No. 6,812,465 issued Nov. 2, 2004, and U.S. patent application Ser. No. 12/114,865 filed May 5, 2008, which are incorporated herein by reference in their entirety.

Referring again to FIG. 5, block 570 may include additional processing of the NUC terms. For example, in one embodiment, to preserve the scene signal mean, the sum of all NUC terms may be normalized to zero by subtracting the NUC term mean from each NUC term. Also in block 570, to avoid row and column noise from affecting the NUC terms, the mean value of each row and column may be subtracted from the NUC terms for each row and column. As a result, row and column FPN filters using the row and column FPN terms determined in block 550 may be better able to filter out row and column noise in further iterations (e.g., as further shown in FIG. 8) after the NUC terms are applied to captured images (e.g., in block 580 further discussed herein). In this regard, the row and column FPN filters may in general use more data to calculate the per row and per column offset coefficients (e.g., row and column FPN terms) and may thus provide a more robust alternative for reducing spatially correlated FPN than the NUC terms which are based on high pass filtering to capture spatially uncorrelated noise.

In blocks 571-573, additional high pass filtering and further determinations of updated NUC terms may be optionally performed to remove spatially correlated FPN with lower spatial frequency than previously removed by row and column FPN terms. In this regard, some variability in infrared sensors 132 or other components of infrared imaging module 100 may result in spatially correlated FPN noise that cannot be easily modeled as row or column noise. Such spatially correlated FPN may include, for example, window defects on a sensor package or a cluster of infrared sensors 132 that respond differently to irradiance than neighboring infrared sensors 132. In one embodiment, such spatially correlated FPN may be mitigated with an offset correction. If the amount of such spatially correlated FPN is significant, then the noise may also be detectable in the blurred image frame. Since this type of noise may affect a neighborhood of pixels, a high pass filter with a small kernel may not detect the FPN in the neighborhood (e.g., all values used in high pass filter may be taken from the neighborhood of affected pixels and thus may be affected by the same offset error). For example, if the high pass filtering of block 565 is performed with a small kernel (e.g., considering only immediately adjacent pixels that fall within a neighborhood of pixels affected by spatially correlated FPN), then broadly distributed spatially correlated FPN may not be detected.

For example, FIG. 11 illustrates spatially correlated FPN in a neighborhood of pixels in accordance with an embodiment of the disclosure. As shown in a sample image frame 1100, a neighborhood of pixels 1110 may exhibit spatially correlated FPN that is not precisely correlated to individual rows and columns and is distributed over a neighborhood of several pixels (e.g., a neighborhood of approximately 4 by 4 pixels in this example). Sample image frame 1100 also includes a set of pixels 1120 exhibiting substantially uniform response that are not used in filtering calculations, and a set of pixels 1130 that are used to estimate a low pass value for the neighborhood of pixels 1110. In one embodiment, pixels 1130 may be a number of pixels divisible by two in order to facilitate efficient hardware or software calculations.

Referring again to FIG. 5, in blocks 571-573, additional high pass filtering and further determinations of updated NUC terms may be optionally performed to remove spatially correlated FPN such as exhibited by pixels 1110. In block 571, the updated NUC terms determined in block 570 are applied to the blurred image frame. Thus, at this time, the blurred image frame will have been initially corrected for spatially correlated FPN (e.g., by application of the updated row and column FPN terms in block 555), and also initially corrected for spatially uncorrelated FPN (e.g., by application of the updated NUC terms applied in block 571).

In block 572, a further high pass filter is applied with a larger kernel than was used in block 565, and further updated NUC terms may be determined in block 573. For example, to detect the spatially correlated FPN present in pixels 1110, the high pass filter applied in block 572 may include data from a sufficiently large enough neighborhood of pixels such that differences can be determined between unaffected pixels (e.g., pixels 1120) and affected pixels (e.g., pixels 1110). For example, a low pass filter with a large kernel can be used (e.g., an N by N kernel that is much greater than 3 by 3 pixels) and the results may be subtracted to perform appropriate high pass filtering.

In one embodiment, for computational efficiency, a sparse kernel may be used such that only a small number of neighboring pixels inside an N by N neighborhood are used. For any given high pass filter operation using distant neighbors (e.g., a large kernel), there is a risk of modeling actual (potentially blurred) scene information as spatially correlated FPN. Accordingly, in one embodiment, the temporal damping factor λ may be set close to 1 for updated NUC terms determined in block 573.

In various embodiments, blocks 571-573 may be repeated (e.g., cascaded) to iteratively perform high pass filtering with increasing kernel sizes to provide further updated NUC terms further correct for spatially correlated FPN of desired neighborhood sizes. In one embodiment, the decision to perform such iterations may be determined by whether spatially correlated FPN has actually been removed by the updated NUC terms of the previous performance of blocks 571-573.

After blocks 571-573 are finished, a decision is made regarding whether to apply the updated NUC terms to captured image frames (block 574). For example, if an average of the absolute value of the NUC terms for the entire image frame is less than a minimum threshold value, or greater than a maximum threshold value, the NUC terms may be deemed spurious or unlikely to provide meaningful correction. Alternatively, thresholding criteria may be applied to individual pixels to determine which pixels receive updated NUC terms. In one embodiment, the threshold values may correspond to differences between the newly calculated NUC terms and previously calculated NUC terms. In another embodiment, the threshold values may be independent of previously calculated NUC terms. Other tests may be applied (e.g., spatial correlation tests) to determine whether the NUC terms should be applied.

If the NUC terms are deemed spurious or unlikely to provide meaningful correction, then the flow diagram returns to block 505. Otherwise, the newly determined NUC terms are stored (block 575) to replace previous NUC terms (e.g., determined by a previously performed iteration of FIG. 5) and applied (block 580) to captured image frames.

FIG. 8 illustrates various image processing techniques of FIG. 5 and other operations applied in an image processing pipeline 800 in accordance with an embodiment of the disclosure. In this regard, pipeline 800 identifies various operations of FIG. 5 in the context of an overall iterative image processing scheme for correcting image frames provided by infrared imaging module 100. In some embodiments, pipeline 800 may be provided by processing module 160 or processor 195 (both also generally referred to as a processor) operating on image frames captured by infrared sensors 132.

Image frames captured by infrared sensors 132 may be provided to a frame averager 804 that integrates multiple image frames to provide image frames 802 with an improved signal to noise ratio. Frame averager 804 may be effectively provided by infrared sensors 132, ROIC 402, and other components of infrared sensor assembly 128 that are implemented to support high image capture rates. For example, in one embodiment, infrared sensor assembly 128 may capture infrared image frames at a frame rate of 240 Hz (e.g., 240 images per second). In this embodiment, such a high frame rate may be implemented, for example, by operating infrared sensor assembly 128 at relatively low voltages (e.g., compatible with mobile telephone voltages) and by using a relatively small array of infrared sensors 132 (e.g., an array of 64 by 64 infrared sensors in one embodiment).

In one embodiment, such infrared image frames may be provided from infrared sensor assembly 128 to processing module 160 at a high frame rate (e.g., 240 Hz or other frame rates). In another embodiment, infrared sensor assembly 128 may integrate over longer time periods, or multiple time periods, to provide integrated (e.g., averaged) infrared image frames to processing module 160 at a lower frame rate (e.g., 30 Hz, 9 Hz, or other frame rates). Further information regarding implementations that may be used to provide high image capture rates may be found in U.S. Provisional Patent Application No. 61/495,879 previously referenced herein.

Image frames 802 proceed through pipeline 800 where they are adjusted by various terms, temporally filtered, used to determine the various adjustment terms, and gain compensated.

In blocks 810 and 814, factory gain terms 812 and factory offset terms 816 are applied to image frames 802 to compensate for gain and offset differences, respectively, between the various infrared sensors 132 and/or other components of infrared imaging module 100 determined during manufacturing and testing.

In block 580, NUC terms 817 are applied to image frames 802 to correct for FPN as discussed. In one embodiment, if NUC terms 817 have not yet been determined (e.g., before a NUC process has been initiated), then block 580 may not be performed or initialization values may be used for NUC terms 817 that result in no alteration to the image data (e.g., offsets for every pixel would be equal to zero).

In blocks 818 and 822, column FPN terms 820 and row FPN terms 824, respectively, are applied to image frames 802. Column FPN terms 820 and row FPN terms 824 may be determined in accordance with block 550 as discussed. In one embodiment, if the column FPN terms 820 and row FPN terms 824 have not yet been determined (e.g., before a NUC process has been initiated), then blocks 818 and 822 may not be performed or initialization values may be used for the column FPN terms 820 and row FPN terms 824 that result in no alteration to the image data (e.g., offsets for every pixel would be equal to zero).

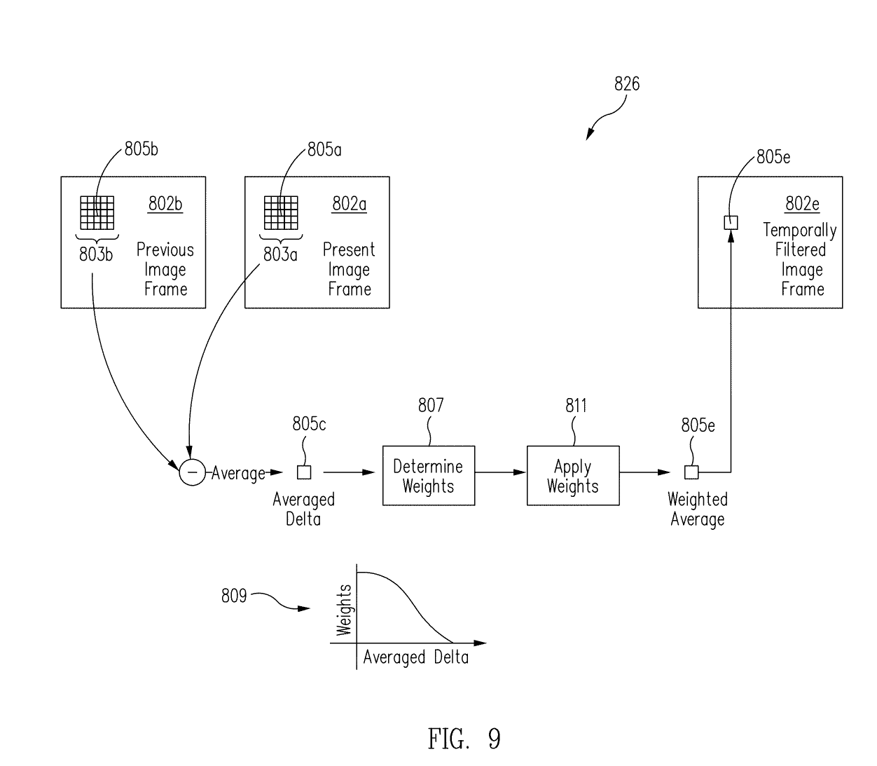

In block 826, temporal filtering is performed on image frames 802 in accordance with a temporal noise reduction (TNR) process. FIG. 9 illustrates a TNR process in accordance with an embodiment of the disclosure. In FIG. 9, a presently received image frame 802a and a previously temporally filtered image frame 802b are processed to determine a new temporally filtered image frame 802e. Image frames 802a and 802b include local neighborhoods of pixels 803a and 803b centered around pixels 805a and 805b, respectively. Neighborhoods 803a and 803b correspond to the same locations within image frames 802a and 802b and are subsets of the total pixels in image frames 802a and 802b. In the illustrated embodiment, neighborhoods 803a and 803b include areas of 5 by 5 pixels. Other neighborhood sizes may be used in other embodiments.

Differences between corresponding pixels of neighborhoods 803a and 803b are determined and averaged to provide an averaged delta value 805c for the location corresponding to pixels 805a and 805b. Averaged delta value 805c may be used to determine weight values in block 807 to be applied to pixels 805a and 805b of image frames 802a and 802b.

In one embodiment, as shown in graph 809, the weight values determined in block 807 may be inversely proportional to averaged delta value 805c such that weight values drop rapidly towards zero when there are large differences between neighborhoods 803a and 803b. In this regard, large differences between neighborhoods 803a and 803b may indicate that changes have occurred within the scene (e.g., due to motion) and pixels 802a and 802b may be appropriately weighted, in one embodiment, to avoid introducing blur across frame-to-frame scene changes. Other associations between weight values and averaged delta value 805c may be used in various embodiments.

The weight values determined in block 807 may be applied to pixels 805a and 805b to determine a value for corresponding pixel 805e of image frame 802e (block 811). In this regard, pixel 805e may have a value that is a weighted average (or other combination) of pixels 805a and 805b, depending on averaged delta value 805c and the weight values determined in block 807.

For example, pixel 805e of temporally filtered image frame 802e may be a weighted sum of pixels 805a and 805b of image frames 802a and 802b. If the average difference between pixels 805a and 805b is due to noise, then it may be expected that the average change between neighborhoods 805a and 805b will be close to zero (e.g., corresponding to the average of uncorrelated changes). Under such circumstances, it may be expected that the sum of the differences between neighborhoods 805a and 805b will be close to zero. In this case, pixel 805a of image frame 802a may both be appropriately weighted so as to contribute to the value of pixel 805e.

However, if the sum of such differences is not zero (e.g., even differing from zero by a small amount in one embodiment), then the changes may be interpreted as being attributed to motion instead of noise. Thus, motion may be detected based on the average change exhibited by neighborhoods 805a and 805b. Under these circumstances, pixel 805a of image frame 802a may be weighted heavily, while pixel 805b of image frame 802b may be weighted lightly.

Other embodiments are also contemplated. For example, although averaged delta value 805c has been described as being determined based on neighborhoods 805a and 805b, in other embodiments averaged delta value 805c may be determined based on any desired criteria (e.g., based on individual pixels or other types of groups of sets of pixels).

In the above embodiments, image frame 802a has been described as a presently received image frame and image frame 802b has been described as a previously temporally filtered image frame. In another embodiment, image frames 802a and 802b may be first and second image frames captured by infrared imaging module 100 that have not been temporally filtered.

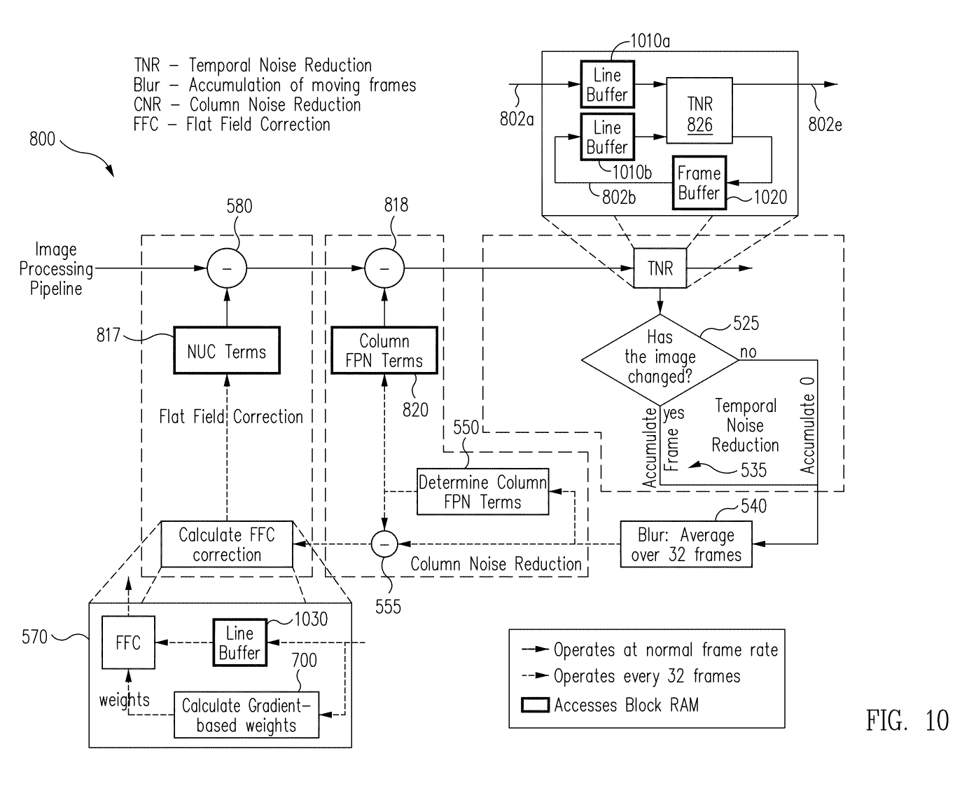

FIG. 10 illustrates further implementation details in relation to the TNR process of block 826. As shown in FIG. 10, image frames 802a and 802b may be read into line buffers 1010a and 1010b, respectively, and image frame 802b (e.g., the previous image frame) may be stored in a frame buffer 1020 before being read into line buffer 1010b. In one embodiment, line buffers 1010a-b and frame buffer 1020 may be implemented by a block of random access memory (RAM) provided by any appropriate component of infrared imaging module 100 and/or host device 102.

Referring again to FIG. 8, image frame 802e may be passed to an automatic gain compensation block 828 for further processing to provide a result image frame 830 that may be used by host device 102 as desired.

FIG. 8 further illustrates various operations that may be performed to determine row and column FPN terms and NUC terms as discussed. In one embodiment, these operations may use image frames 802e as shown in FIG. 8. Because image frames 802e have already been temporally filtered, at least some temporal noise may be removed and thus will not inadvertently affect the determination of row and column FPN terms 824 and 820 and NUC terms 817. In another embodiment, non-temporally filtered image frames 802 may be used.

In FIG. 8, blocks 510, 515, and 520 of FIG. 5 are collectively represented together. As discussed, a NUC process may be selectively initiated and performed in response to various NUC process initiating events and based on various criteria or conditions. As also discussed, the NUC process may be performed in accordance with a motion-based approach (blocks 525, 535, and 540) or a defocus-based approach (block 530) to provide a blurred image frame (block 545). FIG. 8 further illustrates various additional blocks 550, 552, 555, 560, 565, 570, 571, 572, 573, and 575 previously discussed with regard to FIG. 5.

As shown in FIG. 8, row and column FPN terms 824 and 820 and NUC terms 817 may be determined and applied in an iterative fashion such that updated terms are determined using image frames 802 to which previous terms have already been applied. As a result, the overall process of FIG. 8 may repeatedly update and apply such terms to continuously reduce the noise in image frames 830 to be used by host device 102.

Referring again to FIG. 10, further implementation details are illustrated for various blocks of FIGS. 5 and 8 in relation to pipeline 800. For example, blocks 525, 535, and 540 are shown as operating at the normal frame rate of image frames 802 received by pipeline 800. In the embodiment shown in FIG. 10, the determination made in block 525 is represented as a decision diamond used to determine whether a given image frame 802 has sufficiently changed such that it may be considered an image frame that will enhance the blur if added to other image frames and is therefore accumulated (block 535 is represented by an arrow in this embodiment) and averaged (block 540).

Also in FIG. 10, the determination of column FPN terms 820 (block 550) is shown as operating at an update rate that in this example is 1/32 of the sensor frame rate (e.g., normal frame rate) due to the averaging performed in block 540. Other update rates may be used in other embodiments. Although only column FPN terms 820 are identified in FIG. 10, row FPN terms 824 may be implemented in a similar fashion at the reduced frame rate.

FIG. 10 also illustrates further implementation details in relation to the NUC determination process of block 570. In this regard, the blurred image frame may be read to a line buffer 1030 (e.g., implemented by a block of RAM provided by any appropriate component of infrared imaging module 100 and/or host device 102). The flat field correction technique 700 of FIG. 7 may be performed on the blurred image frame.

In view of the present disclosure, it will be appreciated that techniques described herein may be used to remove various types of FPN (e.g., including very high amplitude FPN) such as spatially correlated row and column FPN and spatially uncorrelated FPN.

Other embodiments are also contemplated. For example, in one embodiment, the rate at which row and column FPN terms and/or NUC terms are updated can be inversely proportional to the estimated amount of blur in the blurred image frame and/or inversely proportional to the magnitude of local contrast values (e.g., determined in block 560).

In various embodiments, the described techniques may provide advantages over conventional shutter-based noise correction techniques. For example, by using a shutterless process, a shutter (e.g., such as shutter 105) need not be provided, thus permitting reductions in size, weight, cost, and mechanical complexity. Power and maximum voltage supplied to, or generated by, infrared imaging module 100 may also be reduced if a shutter does not need to be mechanically operated. Reliability will be improved by removing the shutter as a potential point of failure. A shutterless process also eliminates potential image interruption caused by the temporary blockage of the imaged scene by a shutter.

Also, by correcting for noise using intentionally blurred image frames captured from a real world scene (not a uniform scene provided by a shutter), noise correction may be performed on image frames that have irradiance levels similar to those of the actual scene desired to be imaged. This can improve the accuracy and effectiveness of noise correction terms determined in accordance with the various described techniques.

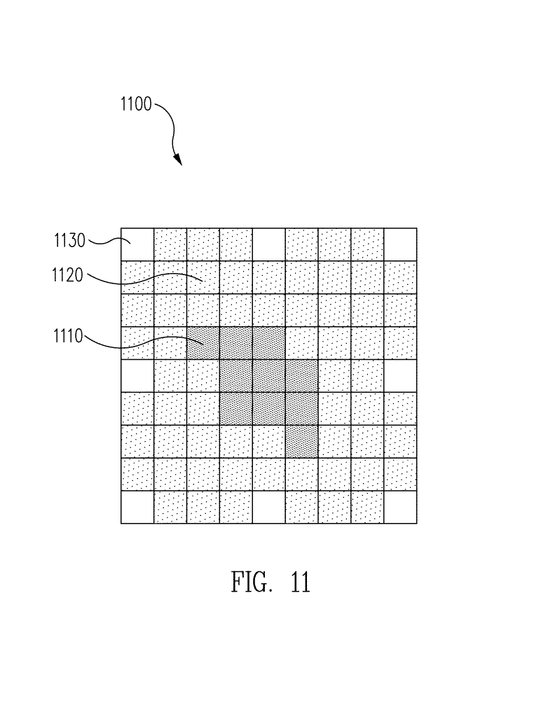

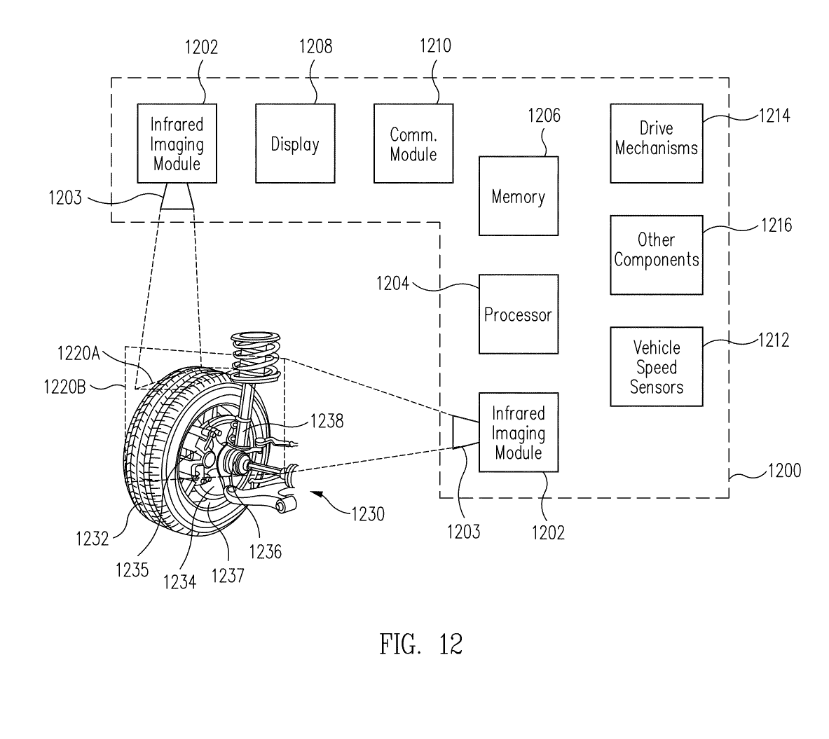

Referring now to FIG. 12, a block diagram is shown of a vehicle-mounted system 1200 for monitoring components of a wheel assembly 1230 in accordance with an embodiment of the disclosure. Vehicle-mounted system 1200 may include one or more infrared imaging modules 1202, a processor 1204, a memory 1206, a display 1208, a communication module 1210, vehicle speed sensors 1212, drive mechanisms 1214, and/or other components 1216. In various embodiments, components of vehicle-mountable system 1200 may be implemented in the same or similar manner as corresponding components of host device 102 of FIG. 1. Moreover, components of vehicle-mountable system 1200 may be configured to perform various NUC processes and other processes described herein.

In some embodiments, infrared imaging module 1202 may be a small form factor infrared camera or a small form factor infrared imaging device implemented in accordance with various embodiments disclosed herein. Infrared imaging module 1202 may include an FPA implemented, for example, in accordance with various embodiments disclosed herein or others where appropriate.

Infrared imaging module 1202 may be configured to capture, process, and/or otherwise manage infrared images (e.g., including thermal images) of a desired portion of wheel assembly 1230. In this regard, infrared imaging module 1202 may be mounted anywhere in or on a vehicle so that a desired portion of wheel assembly 1230 is within a field of view (FOV) of infrared imaging module 1202. For example, infrared imaging module 1202 may be positioned so that a tread of a tire 1232 is within an FOV 1220A, as shown in FIG. 12.

In another example, infrared imaging module 1202 may be positioned to so that a brake rotor or drum 1234, a brake caliper 1235, a wheel hub 1236, a side wall of tire 1232, and other wheel assembly components (e.g., a strut 1238) are within an FOV 1220B, as also shown in FIG. 12.

It will be appreciated that infrared imaging module 1202 may be positioned to view any other component (e.g., various suspension links, joints, shock absorbers, springs, and other components that are near and/or connected to wheel assembly 1230). Infrared imaging module 1202 may be mounted in or on various components of wheel assembly 1230 itself, for example, on an outer circumference of a rim 1237 internal to tire 1232, on a suspension link, or on strut 1238, in order to obtain a view of desired components. Note also that some components (e.g., a brake backing plate) that may obstruct view of a desired portion of wheel assembly 1230 may be removed or made of infrared-transmissive materials to allow infrared radiation from the desired portion to reach infrared imaging module 1202.

In some embodiments, infrared imaging module 1202 may include various optical elements 1203 (e.g., infrared-transmissive lens, infrared-transmissive prisms, infrared-reflective mirrors, infrared fiber optics) that guide infrared rays from a desired portion of wheel assembly 1230 to an FPA of infrared imaging module 1202. Optical elements 1203 may be useful when it is difficult to mount infrared imaging module 1202 at a desired location. For example, a flexible fiber-optic cable may be utilized to route infrared rays from a hard-to-reach component (e.g., brake pads) to infrared imaging module 1202 mounted on the body of a vehicle away from the hard-to-reach component. Note also that optical elements 1203 may be used to suitably define or alter an FOV of infrared imaging module 1202. A switchable FOV (e.g., selectable by infrared imaging module 1202 and/or processor 1204) may optionally be provided, which may be useful, for example, when a close-up view of a component is desired.

Infrared images captured, processed, and/or otherwise managed by infrared imaging module 1202 may be radiometrically normalized infrared images (e.g., thermal images). That is, pixels that make up the captured image may contain calibrated thermal data (e.g., temperature). As discussed above in connection with infrared imaging module 100 of FIG. 1, infrared imaging module 1202 and/or associated components may be calibrated using appropriate techniques so that images captured by infrared imaging module 1202 are properly calibrated thermal images. In some embodiments, appropriate calibration processes may be performed periodically by infrared imaging module 1202 and/or processor 1204 so that infrared imaging module 1202, and hence the thermal images captured by it, may maintain proper calibration.

Processor 1204 may be implemented as any appropriate processing device as described with regard to processor 195 in FIG. 1. In some embodiments, processor 1204 may be part of or implemented with other conventional on-board processors that may be installed on a vehicle. For example, a modern vehicle may have a processor for controlling and monitoring various mechanical operations of a vehicle, a processor for an on-board entertainment and vehicle information system, a processor for a satellite navigation system, and/or a processor for a remote diagnostics system, any of which may be utilized to implement all or part of processor 1204. In other embodiments, processor 1204 may interface and communicate with such other conventional on-board processors and components associated with such processors.

Processor 1204 may be configured to interface and communicate with other components of vehicle-mounted system 1200 to perform methods and processes described herein. Processor 1204 may be configured to receive thermal images of one or more desired portions of wheel assembly 1230 captured by one or more infrared imaging modules 1202, and perform various thermal image processing operations as further described herein to determine the condition of various components of wheel assembly 1230. Processor 1204 may be further configured to compile, analyze, or otherwise process the determined condition to generate monitoring information about the condition of various components of wheel assembly 1230.

For example, processor 1204 may determine, from calibrated thermal images provided by infrared imaging module 1202, aggregate temperature of a component or temperature of specific area of a component. Processor 1204 may generate monitoring information that includes, for example, a temperature reading based on the determined temperature. Processor 1202 may further determine whether the temperature of a component is within a normal operating temperature range, and generate monitoring information that includes an alarm if the temperature is outside a safe range.

In another example, processor 1204 may perform various thermal image processing operations and thermal image analytics on thermal images of a tire tread (e.g., a tread of tire 1232) to obtain temperature distribution and variance profiles of the tire tread. Processor 1204 may correlate and/or match the obtained profiles to those of abnormal conditions to detect, for example, a flat tire, a tire tread separation, a tire leak, an underinflated tire, an overinflated tire, a suspension misalignment, an unbalanced wheel, a worn suspension, a worn tire, or other conditions, as further described herein.

In yet another example, processor 1204 may perform various thermal image processing operations and thermal image analytics on thermal images of a brake assembly (e.g., including brake drum or rotor 1234, brake caliper 1235, a brake pad, a brake line) and/or other wheel assembly components to detect cracks, leaks, foreign objects, deformation, and other abnormal conditions. Based on the detection, processor 1204 may generate monitoring information that includes an alarm that warns of detected abnormal conditions and a description of abnormal conditions.

In some embodiments, processor 1204 may be configured to convert thermal images of one or more desired portions of wheel assembly 1230 into user-viewable images (e.g., thermograms) using appropriate methods and algorithms. For example, thermographic data contained in thermal images may be converted into gray-scaled or color-scaled pixels to construct images that can be viewed by a person. User-viewable images may optionally include a legend or scale that indicates the approximate temperature of corresponding pixel color and/or intensity. Such user-viewable images, if presented on a display (e.g., display 1208), may be useful to a user (e.g., a driver or a technician) in confirming or better understanding the abnormal conditions detected by vehicle-mounted system 1200. Monitoring information generated by processor 1204 may include such user-viewable images.

Memory 1206 may include one or more memory devices to store data and information, including thermal images and monitoring information. The one or more memory devices may include various types of memory for thermal image and other information storage including volatile and non-volatile memory devices, such as RAM (Random Access Memory), ROM (Read-Only Memory), EEPROM (Electrically-Erasable Read-Only Memory), flash memory, a disk drive. In one embodiment, thermal images and monitoring information stored in the one or more memory devices may be retrieved (e.g., by a technician using appropriate readers and/or diagnostic tools) for purposes of reviewing and further diagnosing the condition of various components monitored by vehicle-mounted system 1200. In some embodiments, processor 1204 may be configured to execute software instructions stored on memory 1206 to perform various methods, processes, or operations in the manner described herein.

Display 1208 may be configured to present, indicate, or otherwise convey monitoring information generated by processor 1204. In one embodiment, display 1208 may be implemented with various lighted icons, symbols, and/or indicators, which may be similar to conventional indicators and warning lights on a vehicle instrument panel. The various lighted icons, symbols, and/or indicators may be utilized to indicate one or more alarms contained in the monitoring information. The various lighted icons, symbols, or indicators may be complemented with an alpha-numeric display panel (e.g., a segmented LED panel) to display letters and numbers representing other monitoring information, such as a temperature reading, a description or classification of detected abnormal conditions, etc.

In other embodiments, display 1208 may be implemented with an electronic display screen, such as a liquid crystal display (LCD) a cathode ray tube (CRT), or various other types of generally known video displays and monitors. Display 1208 according to such embodiments may be suitable for presenting user-viewable thermal images converted by processor 1204 from thermal images captured by infrared imaging module 1202. It is contemplated that conventional on-board information display screens (e.g., for interfacing with an on-board entertainment system, displaying navigation information, displaying rear view camera images, and displaying various other types of vehicle information) found in modern vehicles may be utilized as display 1208.

Communication module 1210 may be configured to handle communication and interfacing between various components of vehicle-mounted system 1200. For example, components such as infrared imaging module 1202, display 1208, wheel speed sensor 1212 and/or drive mechanisms 1214 may transmit and receive data to and from processor 1204 through communication module 1210, which may manage wired and/or wireless connections (e.g., through proprietary RF links, proprietary infrared links, and/or standard wireless communication protocols such as IEEE 802.11 WiFi standards and Bluetooth™) between the various components. Such wireless connections may allow infrared imaging module 1202 to be mounted where it would not be feasible to provide wired connections, for example, on rim 1237 or other rotating/moving components.

Communication module 1210 may be further configured to allow components of vehicle-mounted system 1200 to communicate and interface with other existing vehicle electronic components. For example, processor 1204 may communicate, via communication module 1210, with a vehicle electronic control unit (ECU), an in-vehicle information and entertainment system, a satellite navigation system, and other existing sensors and electronic components. In this regard, communication module 1210 may support various interfaces, protocols, and standards for in-vehicle networking, such as the controller area network (CAN) bus, the vehicle area network (VAN) standard, the local interconnect network (LIN) bus, the media oriented systems transport (MOST) network, the ISO 11738 (or ISO bus) standard.

In some embodiments, vehicle-mounted system 1200 may comprise as many such communication modules 1210 as desired for various applications of vehicle-mounted system 1200 on various types of vehicle. In other embodiments, communication module 1210 may be integrated into or implemented as part of various other components of vehicle-mounted system 1200. For example, infrared imaging module 1202, processor 1204, and display 1208 may each comprise a subcomponent that may be configured to perform the operations of communication module 1210, and may communicate with one another via wired and/or wireless connection without separate communication module 1210.

Vehicle speed sensors 1212 may include one or more devices that may detect the rotational speed of a wheel and/or the speed of a vehicle. The one or more devices may include a wheel speed sender that reads the rotational speed of a wheel. A wheel speed sender may be implemented in any appropriate manner, including using a mechanical, electromagnetic, and/or optical pickup mechanism attached to a wheel or an axle. The one or more devices may also include a global positioning system-based (GPS-based) speed sensor, an accelerometer, a gyroscope, or other similar devices for determining the speed and/or acceleration of a vehicle, which can also be converted into the rotational speed of a wheel.

The rotational speed of a wheel may be received by processor 1204 and/or infrared imaging module 1202 to decide when to capture thermal images of desired portions of wheel assembly 1230. For example, if sharp thermal images are desired, the rotational speed may be slower than a certain threshold such that the captured thermal images appear to be fixed or static given the frame rate (or capture rate) of infrared imaging module 1202. If blurred thermal images are desired, such as when capturing motion-based blurred thermal images as described herein, thermal images may be captured when the rotational speed is faster than a certain threshold. The threshold may be determined, for example, from the frame rate of infrared imaging module 1202.

The rotational speed of a wheel transmitted by vehicle speed sensors 1212 may also be utilized by processor 1204 to factor in the acceleration, speed, and distance travelled when analyzing thermal images of various components of wheel assembly 1230, as further described herein. For example, component wear may be detected from how fast a component or a certain part of a component heats up relative to the acceleration, speed, and/or distance travelled, but may not necessarily be detectable from a temperature reading alone.

Drive mechanisms 1214 may include actuators, motors, pumps, or other appropriate mechanisms that can be activated or controlled with control signals. Drive mechanisms 1214 may be used to automatically adjust various components of a vehicle in response to the monitoring information generated by processor 1204. For example, vehicle-mounted system 1200 may adjust a suspension geometry using actuators attached to various suspension links and joints if a suspension misalignment is detected. In another example, vehicle-mounted system 1200 may inflate a tire using an on-board pump if underinflation is detected.

Other components 1216 may include, in some embodiments, other sensors such as a temperature sensor (e.g., a thermocouple, an infrared thermometer), a moisture sensor, a vehicle weight sensor (e.g., an axle load sensor), a wheel rotational position sensor, a brake pad wear sensor, and/or a tire pressure sensor. Sensors such as a temperature sensor and a moisture sensor may be utilized by processor 1204 to compensate for environmental conditions, and thereby obtain a more accurate analysis of thermal images of various components of wheel assembly 1230. Sensors such as a brake pad wear sensor and a tire pressure sensor may provide reference data points and/or extra data points that may be utilized by processor 1204 to obtain a more accurate analysis of thermal images of various components of wheel assembly 1230.

Other components 1216 may also include any other device as may be desired for various applications of vehicle-mounted system 1200. In some embodiments, other components 1216 may include a chime, a speaker with associated circuitry for generating a tone, or other appropriate devices that may be used to sound an audible alarm based on monitoring information generated by processor 1204.

In various embodiments, one or more components of vehicle-mounted system 1200 may be combined and/or implemented or not, as desired or depending on application requirements. For example, processor 1204 may be combined with infrared imaging module 1202, memory 1206, display component 1208, and/or communication module 1210. In another example, processor 1204 may be combined with infrared imaging sensor 1202 with only certain operations of processor 1204 performed by circuitry (e.g., processor, logic device, microprocessor, microcontroller, etc.) within infrared imaging module 1202.

Thus, vehicle-mounted system 1200 may be mounted on, installed in, or otherwise integrated into a vehicle to provide on-board and real-time monitoring of the condition of various vehicle wheel assembly components, such as tires, brakes, wheel hub bearings, struts, suspension links and joints, etc. It is also contemplated that vehicle-mounted system 1200 may be adapted or modified to monitor various other components of a vehicle. For example, vehicle-mounted system 1200 may be used for on-board and real-time monitoring of the condition of a vehicle exhaust system (e.g., including exhaust manifolds, catalytic converters, exhaust pipes, muffler, etc.) and detect abnormalities such as a crack formation, a leak, and above-normal temperature, which may indicate a failing catalytic convertor and/or bad combustion in the engine.

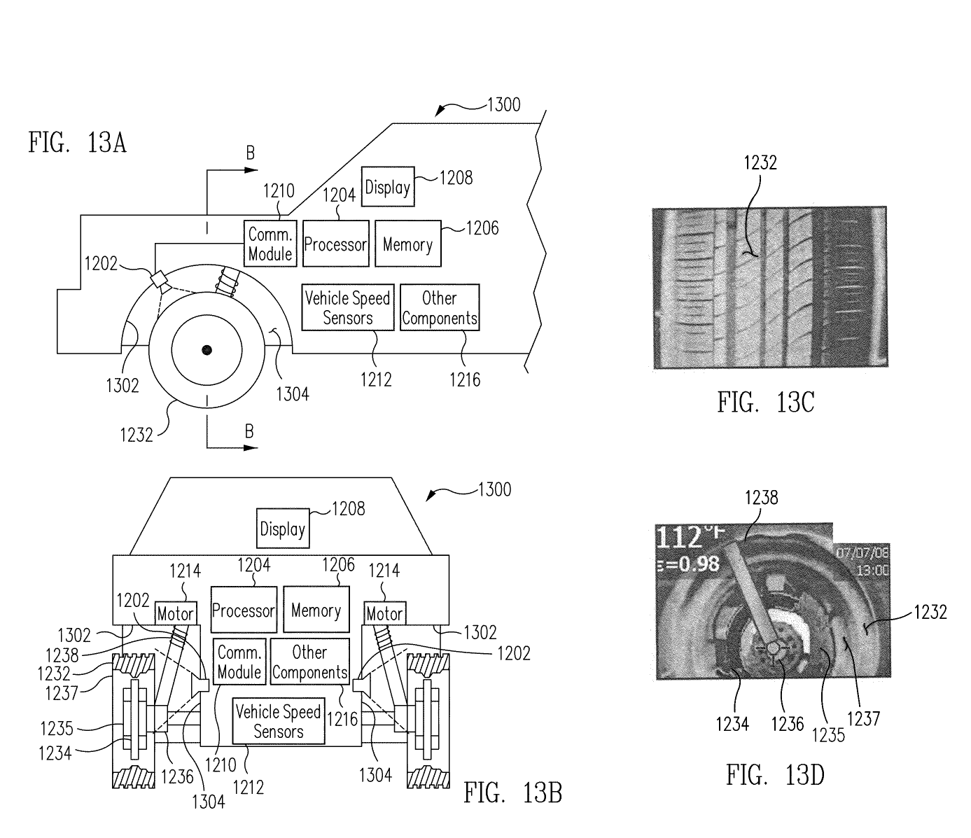

FIGS. 13A-13B show a vehicle 1300 having vehicle-mounted system 1200 for monitoring components of wheel assembly 1230 in accordance with an embodiment of the disclosure. More specifically, FIG. 13A illustrates a sectional side view of vehicle 1300 having vehicle-mounted system 1200, and FIG. 13B illustrates a sectional front view along line B-B of vehicle 1300 having vehicle-mounted system 1200.

As shown in FIG. 13A, in one embodiment, infrared imaging module 1202 may be mounted on an inner fender 1302 of vehicle 1300 so that a tread of tire 1232 is within an FOV of infrared imaging module 1202. FIG. 13C shows an example of a thermal image (shown as a user-viewable thermal image for easier understanding) that may be captured by infrared imaging module 1202 in such an embodiment. As shown, such a thermal image may contain a clear image of thermal radiation from a tread of tire 1232.

As shown in FIG. 13B, in another embodiment, infrared imaging module 1202 may be mounted on a tire well 1304 of vehicle 1300 so that various components including tire 1232, brake rotor or drum 1234, brake caliper 1235, wheel hub 1236, rim 1237, and strut 1238 may be within an FOV of infrared imaging module 1202. FIG. 13D shows an example of a thermal image that may be captured by infrared imaging module 1202 in such an embodiment. As shown, such a thermal image may contain a clear image of thermal radiation from these various components.

The mounting locations shown in FIGS. 13A-13B are merely examples, and infrared imaging module 1202 may be located, positioned, or mounted anywhere on vehicle 1300 to capture thermal images of a desired portion of wheel assembly 1230, as discussed in connection with FIG. 12. A plurality of infrared imaging modules 1202 may be mounted on vehicle 1300 to cover more than one desired portion of wheel assembly 1230 (e.g., one mounted on inner fender 1302 and another on tire well 1304 as shown in FIGS. 13A-13B), and/or to cover any number of wheel assemblies 1230 that may be present on vehicle 1300.

Although vehicle 1300 is depicted as an automobile, vehicle-mounted system 1200 may be mounted on, installed in, or otherwise integrated into various other types of vehicles, such as an aircraft, a locomotive, a train, a truck, a construction equipment, an agricultural equipment, or any other vehicle having a wheel assembly or other appropriate components that may be monitored by vehicle-mounted system 1200.

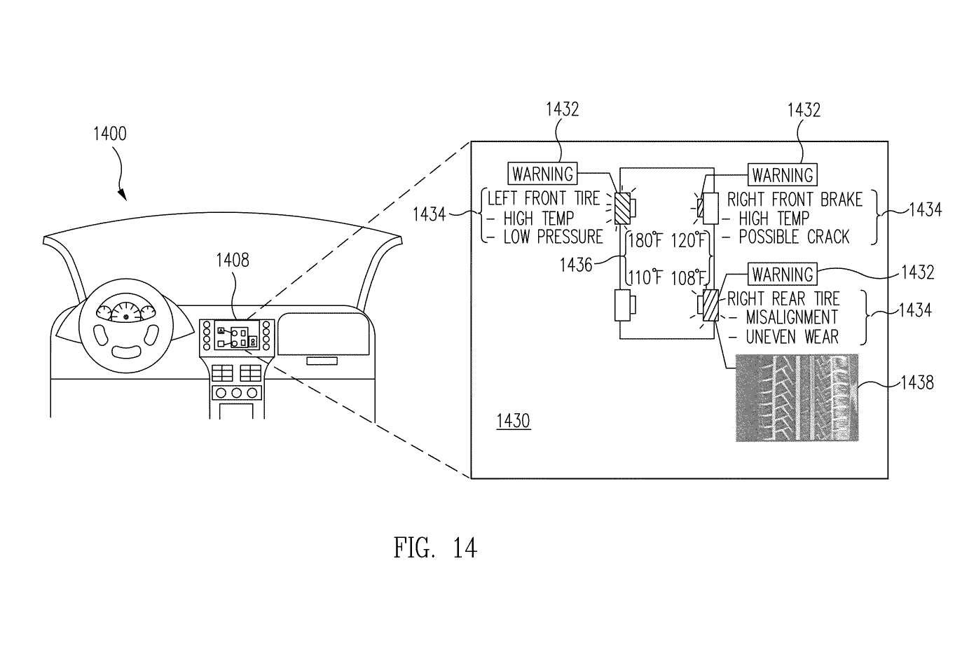

FIG. 14 illustrates a vehicle dashboard 1400 having a display 1408 of vehicle-mounted system 1200 in accordance with an embodiment of the disclosure. Display 1408 in this embodiment may be implemented with an electronic display screen (e.g., an LCD screen, a CRT screen, or other appropriate displays) positioned on vehicle dashboard 1400 to present monitoring information generated by processor 1204 for a convenient viewing by a driver and/or other occupants in a vehicle. As an example screenshot 1430 of display 1408 shows, display 1408 may present monitoring information including one or more alarms 1432, one or more descriptions 1434 of the condition of various components, one or more temperature readings 1436, and/or one or more user-viewable thermal images 1438 of relevant vehicle components. In various embodiments, the monitoring information presented on display 1408 may be provided in text and/or graphic forms. Such monitoring information may be provided additional or alternatively in audible form. Thus, through display 1408, vehicle-mounted system 1200 can present monitoring information, including information that could potentially save lives and/or help avoid costly damages, to a driver or any other occupant onboard in real time (e.g., while a vehicle is being driven).

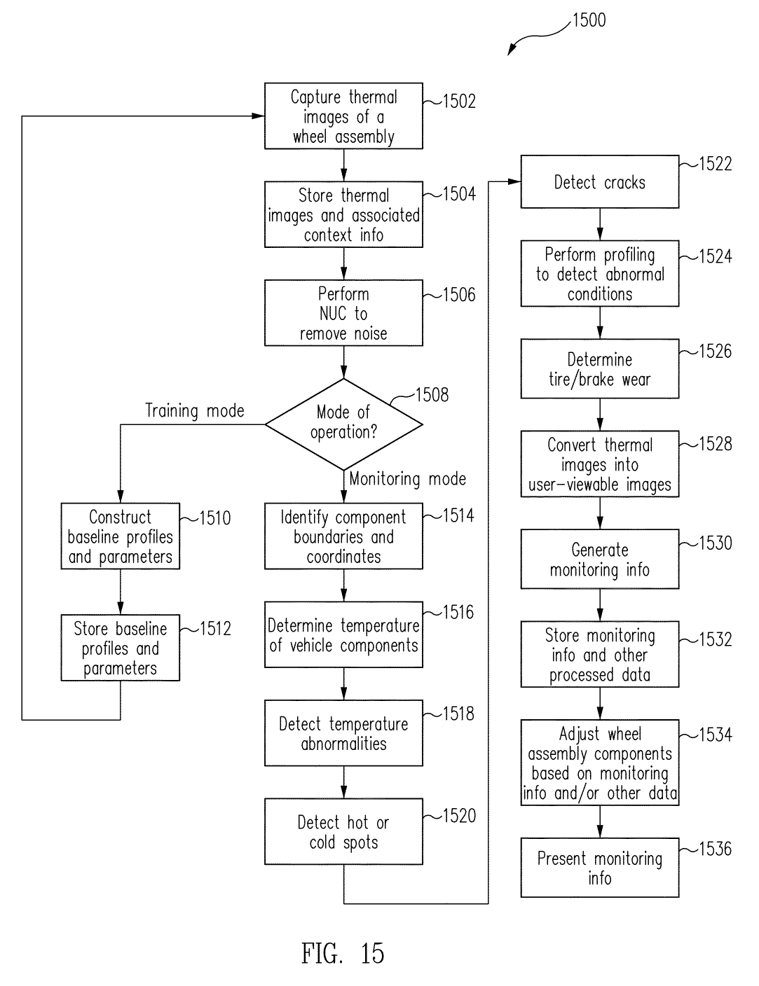

Referring now to FIG. 15, a flowchart is illustrated of a process 1500 for on-board monitoring of a vehicle wheel assembly, in accordance with an embodiment of the disclosure. For example, process 1500 may be performed by vehicle-mounted system 1200 mounted on or in vehicle 1300. It should be appreciated that vehicle-mounted system 1200 and vehicle 1300 are identified only for purposes of giving examples and that any other suitable system may be mounted on any other suitable vehicle to perform all or part of process 1500.

At block 1502, one or more thermal images of desired portions of a vehicle wheel assembly (e.g., wheel assembly 1230) may be captured by one or more infrared imaging modules onboard a vehicle. For example, thermal images containing images of thermal radiation from a tire tread, a brake rotor/drum, a brake caliper, a wheel hub, a tire sidewall, a strut and/or other wheel assembly components may be captured by infrared imaging modules 1202 mounted on inner fender 1302 and tire well 1304 of vehicle 1300, as shown in FIGS. 12-13D. The one or more thermal images may be received, for example, at processor 1204 that is communicatively coupled to one or more infrared imaging modules 1202 via wired or wireless links.

At block 1504, the one or more thermal images and associated context information may be stored, for example, in memory 1206 by processor 1204, by infrared imaging modules 1202, and/or by various sensors (e.g., including vehicle speed sensor 1212). Context information may include various properties and ambient conditions associated with a thermal image, such as a timestamp, the ambient temperature, the load on wheel assemblies (e.g., the laden weight), the location of the wheel assembly (e.g., a left front wheel assembly), the orientation of the wheel assembly (e.g., whether the wheel was turned in or out), the rotational position of the wheel, the speed at which the vehicle was traveling when the thermal image was captured, the distance traveled and time elapsed relative to a reference point, and/or the identification of wheel assembly components and their coordinates in the thermal image.

Context information may guide how a thermal image may be processed, analyzed, and/or used. For example, context information may reveal that a thermal image is of a tire tread taken when traveling at a high speed for a sustained period of time. Such a thermal image may be used to detect abnormally high aggregate temperature, misalignment, and other abnormal conditions as described below. In some embodiments, such a thermal image may be blurred due to the high speed at which the wheel was rotating when taken, and thus may not be sufficiently sharp to detect a worn tire or other abnormal conditions, as further described below. In this and various other ways, context information may be utilized (e.g., by processor 1204) to determine the appropriate application of the associated thermal image. Context information may also supply input parameters for performing thermal image analytics and profiling as further described in detail below. In different embodiments, context information may be collected, processed, or otherwise managed at a processor (e.g., processor 1204) directly without being stored at a separate memory.

At block 1506, an NUC process may be performed on the captured and stored thermal images to remove noise therein, for example, by using various NUC techniques disclosed herein. In one embodiment, context information associated with thermal images may be analyzed to select blurred thermal images (e.g., motion-based blurred thermal images) to be used by an NUC process described herein.

At block 1508, a mode of operation may optionally be determined. The mode of operation may include a training mode and a monitoring mode. For example, using switches, vehicle diagnostic devices, and/or other appropriate input devices, vehicle-mounted system 1200 may be put into a training mode by a user such as a driver or a technician working on the vehicle. Alternatively, vehicle-mounted system 1200 may be put into a training mode automatically when it detects certain trigger conditions, for example, when vehicle-mounted system 1200 is first installed or when new wheel assembly components are installed in the vehicle.

If it is determined, at block 1508, that the system (e.g., vehicle-mounted system 1200) is in a training mode, baseline parameters and profiles may be constructed from the captured thermal images at block 1510. The constructed baseline parameters and profiles may be stored (e.g., in memory 1206) at block 1512.

The baseline parameters and profiles may represent normal operating conditions of the various vehicle components in the thermal images, and include the image coordinates and boundaries, the temperature ranges, the heating and cooling properties (e.g., heat capacity), the temperature distribution and variance patterns, and other properties of the vehicle components in the thermal images. The baseline parameters and profiles may be constructed by collecting and analyzing various statistics. For example, statistical background and foreground modeling techniques (e.g., using a time-series average of pixel values to distinguish a static background from dynamic “regions of interest”) may be utilized to identify the coordinates and boundaries of various components within the thermal images.

The baseline parameters and profiles constructed while in the training mode may be utilized in performing thermal image analytics and profiling during a monitoring mode to determine the condition of various vehicle components in the thermal images. The training mode may be useful when various properties of the vehicle components may deviate from predetermined factory values. For example, aftermarket wheels and tires may be in sizes different from factory wheels and tires, which may be discovered (e.g., as having different image coordinates and boundaries in the thermal images) and recorded at block 1510-1512. In another example, normal operating temperature ranges and temperature distribution patterns may be different for high-performance aftermarket components (e.g., high-performance brake components, high-performance tires), which may tolerate, or even perform better at, a higher temperature.

In some embodiments, the baseline parameters and profiles may be entered manually (e.g., by a technician or mechanic working on the vehicle) without performing blocks 1510-1512. In some embodiments, baseline parameters and profiles may be preprogrammed only at the factory by the manufacturer of the vehicle and/or the installer of the monitoring system (e.g., vehicle-mounted system 1200), and blocks 1508-1512 are not performed.

If it is determined, at block 1508, that the system (e.g., vehicle-mounted system 1200) is in a monitoring mode, thermal image analytics and profiling operations may be performed (e.g., by processor 1204) on the thermal images to determine the condition of various vehicle components and generate corresponding monitoring information.

At block 1514, the boundaries and pixel coordinates may be identified for each vehicle component in the thermal images. For example, in the example thermal image of FIG. 13D, thermal radiation from the tire side wall, the brake rotor, the brake caliper, the wheel hub, and the strut may be distinguished by identifying the boundaries and pixel coordinates of each of them. In the example thermal image of FIG. 13C, the tire tread may be distinguished from the background.

In one embodiment, the baseline parameters and/or the context information associated with the thermal images may supply the boundaries and pixel coordinates for vehicle components in the thermal images. For example, the predetermined (e.g., during a training mode or at the factory) baseline boundaries and coordinates may be adjusted for the wheel assembly orientation (e.g., wheels turned in) according to the context information to arrive at a determination of the boundaries and pixel coordinates without performing further image processing at block 1514.

In another embodiment, the pixel coordinates and boundaries for each vehicle component may be identified in real time by performing edge detection algorithms, blob detection algorithms, and/or other appropriate image processing algorithms on the thermal images. In various embodiments, any combination of the real-time image processing operations, the context information, and the baseline parameters may be used in identifying vehicle component boundaries and coordinates and boundaries within the thermal images.

At block 1516, the temperature of various vehicle components may be determined from the thermal images that contain images of thermal radiation from the various vehicle components. As discussed with respect to infrared imaging module 1202 of FIG. 12, the thermal images may be radiometrically calibrated to contain calibrated temperature data of each pixel in the thermal images. By analyzing the pixels that correspond to the thermal radiation from a certain vehicle component, a temperature reading of all or part of the vehicle component may be obtained. The temperature reading may be further refined by using the emissivity of the materials that make up the component.

At block 1518, the temperature readings obtained at block 1516 may be compared against the baseline parameters and profiles to determine whether the temperature of the various vehicle components are within normal operating ranges. Abnormal operating temperature of vehicle components may indicate an impending failure or an occurrence of a failure. In addition, abnormal operating temperature generally leads to decreased performance even if there is no complete failure of a vehicle component. For example, abnormally high temperature of a tire tread may cause decreased tire traction and may eventually lead to a failure of the tire (e.g., a tire tread separation, a tire blowout). Similarly, abnormally high temperature of a brake assembly (a brake rotor/drum, a brake pad, a brake caliper) may lead to an eventual failure as well as an increased stopping distance. In another example, abnormally high temperature of a wheel hub may indicate an increased friction and an eventual failure (e.g., a seizure) of a wheel hub bearing.

If one or more abnormal temperature conditions are detected, an alarm flag may be set accordingly so that appropriate alarms may be included in the monitoring information. For example, an alarm flag may indicate an abnormally high temperature condition of a certain component (e.g., left front tire).

At block 1520, the thermal images may be analyzed to detect hot spots or cold spots. Hot spots or cold spots are localized spots or regions that deviate from overall temperature of a vehicle component. Hot spots or cold spots generally indicate formation and development of structural failure points, which may eventually lead to a failure of the vehicle component. It will be appreciated that because hot or cold spots are localized, the aggregate temperature of the vehicle component being monitored may still be in a normal range. Thus, hot or cold spot detection may detect and warn of additional dangerous conditions that may not be revealed by abnormal temperature detection alone.

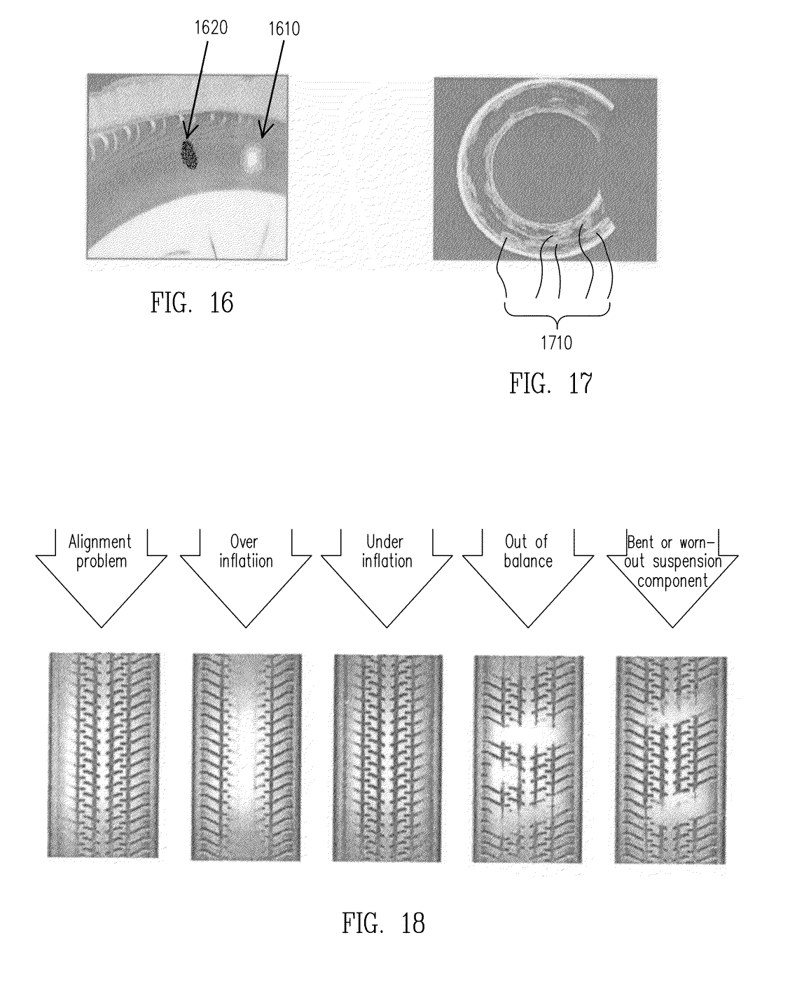

For example, a cold spot on a tire likely indicates formation of a separation (e.g., a “bubble”) of layers in a tire, which may eventually lead to a dangerous tire blowout or a tire tread or wall separation. Similarly, a hot spot on a tire likely indicates formation of a structural weakness in a tire, which may eventually lead to a dangerous tire blowout or a tire tread or wall separation. In addition, a small hot spot or cold spot may indicate a tire air leak. An example user-viewable thermal image of FIG. 16 shows a hot spot 1610 and a cold spot 1620 that are clearly distinguishable from the rest of a tire side wall.

In another example, hot spots on a brake rotor may indicate brake glazing or high spot formation (e.g., brake pad material or other foreign materials built up on a brake rotor surface), which may lead to brake shudder and/or decreased braking performance. An example user-viewable thermal image of a brake rotor in FIG. 17 shows hot spots 1710 on a brake rotor.

In one embodiment, these and other hot or cold spots on various vehicle components may be detected by performing blob detection operations or other appropriate thermal image analytics on sharp (e.g., unblurred) thermal images of desired portions (e.g., portions that include vehicle components to be monitored) of a wheel assembly. As described in connection with block 1504, the context information associated with a thermal image may be analyzed to determine whether the thermal image is sharp or blurred. Blob detection operations or other appropriate thermal image analytics may be performed if the thermal image is determined to be sufficiently sharp based on the context information. If one or more hot or cold spots are detected, an alarm flag may be set accordingly so that appropriate alarms may be included in the monitoring information.

At block 1522, the thermal images may be analyzed (e.g., by processor 1204) to detect cracks in vehicle components. Various vehicle components, such as a rim, a strut, a brake rotor, and a suspension link, may develop cracks. Because such cracks generally manifest themselves in thermal images as thermal gradient discontinuities, they can be detected, in one embodiment, by performing line detection operations, edge detection operations, or other appropriate operations for detecting thermal gradient discontinuities on thermal images of such vehicle components. Similar to hot or cold spot detection, crack detection may be performed if a thermal image is determined to be sufficiently sharp based on the context information. If one or more cracks are detected, an alarm flag may be set accordingly so that appropriate alarms may be included in the monitoring information.

At block 1524, the thermal images may be analyzed (e.g., by processor 1204) to obtain temperature distribution and variance profiles of vehicle components in the thermal images, and to detect abnormal conditions of a vehicle using the profiles obtained from the thermal images. Various abnormal conditions may be indicated from uneven temperature distribution and variance in a vehicle component. For example, FIG. 18 shows various uneven temperature distribution and variance patterns that may be exhibited on a tire tread. As example patterns in FIG. 18 show, concentration of higher temperature on one shoulder may indicate a misalignment of a vehicle suspension, concentration of higher temperature in the central region may indicate an overinflated tire, concentration of higher temperature on both shoulders may indicate an underinflated or flat tire, random patches of high temperature regions may indicate an out-of-balance tire, and bands of high temperature regions spaced apart along a tire tread may indicate bent or worn suspension components.

In one embodiment, the temperature distribution and variance profiles obtained from the thermal images may be correlated, matched, profiled, or otherwise compared against predefined temperature distribution and variance profiles of abnormal conditions, such as the profiles that correspond to the various patterns in FIG. 18, to detect and identify various abnormal conditions. For example, processor 1204 may detect and identify that a vehicle has a misaligned suspension if the obtained profile matches that of a misalignment condition.

In another embodiment, abnormal conditions may be detected by comparing the profiles obtained from the thermal images against the baseline profiles described above in connection with blocks 1510-1512. Because the baseline profiles may represent normal operating profiles of vehicle components, deviation (e.g., an uneven temperature distribution) from the baseline profiles may indicate abnormal conditions. For example, the temperature distribution and variance profile of a brake rotor that has a warp, glazing, high spot formation, or other brake problems likely deviates from the baseline profile representing a smooth and even temperature distribution and variance.

In yet another embodiment, any uneven temperature distribution and variance may be detected as abnormal without comparing it to abnormal condition profiles or baseline profiles. In various embodiments, any combination of the profiling operations described above may be utilized to detect abnormal conditions.

In embodiments where the obtained profiles are compared against abnormal condition profiles and/or baseline profiles, the context information associated with the thermal images may be analyzed to select appropriate profiles. For example, some abnormal condition profiles and/or baseline profiles may be configured to be compared against profiles obtained from unblurred (e.g., low rotation speed) thermal images. Such abnormal condition profiles and/or baseline profiles may be selected to be compared against, if the context information indicates that the thermal images are unblurred.

In embodiments where the obtained profiles are compared against abnormal condition profiles, various profiling operations may be adjusted based on the baseline profiles. For example, data points in abnormal condition profiles may be offset, shifted, or otherwise altered to compensate for a baseline profile that differs from a predefined factory profile (e.g., when a custom suspension setting makes an uneven temperature distribution the norm).

If one or more abnormal conditions are detected through the various profiling operations described above for block 1524, an alarm flag may be set accordingly so that appropriate alarms may be included in the monitoring information.

It will be appreciated that process 1500, including the various profiling operations in block 1524, may permit early detection of some abnormal conditions that otherwise may remain undetected until the effected vehicle components are permanently damaged. For example, the profiling operations in block 1524 may detect uneven tire tread temperature distribution patterns such as those shown in FIG. 18, which indicate conditions that could remain undetected even when conventional tire pressure sensors are installed, until the damage to the tire becomes apparent due to uneven wear. Thus, process 1500 permits early detection that may allow vehicle owners to save cost by avoiding premature wear of vehicle components.

At block 1526, tire wear and/or brake wear may be determined. In one embodiment, brake and/or tire wear may be determined by tracking degradation in heat capacity of a tire and/or brake components (e.g., a brake rotor, a brake drum, a brake pad, and a brake shoe). As generally known, brakes and tires can be viewed as heat sinks which dissipate friction heat converted from kinetic energy. As such, degradation in heat capacity may indicate wear (e.g., loss of brake rotor mass) of brakes or tires.

The heat capacity may be obtained by correlating the brake and/or tire temperature change with acceleration or deceleration force for a given interval. For example, with two or more thermal images, the temperature differences may be determined (e.g., by comparing the temperature readings obtained at block 1516), and the acceleration or deceleration force may be derived from the context information (containing vehicle speed readings, timestamps, vehicle weight, and other relevant data) associated with the two or more thermal images. If the heat capacity degrades to a certain level relative to the baseline, an alarm flag may be set accordingly so that appropriate alarms may be included in the monitoring information.

In another embodiment, tire wear may be determined by comparing the temperature differential between raised surfaces and grooves of a tire tread. As generally known, grooves of a tire tread reach a higher operating temperature than raised surfaces of a tire tread, due to heat generated from hysteresis loss (e.g., due to deformation of tire walls). However, the temperature differential between the tire tread grooves and surfaces may decrease as the grooves become shallow due to tread surface wear.

Thus, in this embodiment, tire wear may be determined from thermal images of a tire tread, which may be analyzed to detect grooves (e.g., by performing edge and/or line detection operations) and obtain the temperature differential between the detected grooves and the raised surfaces. For example, processor 1204 may perform the temperature differential analysis if the context information indicates that the thermal image is sharp (e.g., unblurred) and contains an image (e.g., the thermal image of FIG. 13C) of thermal radiation from a tire tread that has reached a normal operating temperature. If the temperature differential is below the threshold for a given condition, an alarm flag may be set accordingly so that appropriate alarms may be included in the monitoring information.

At block 1528, the thermal images may be converted into user-viewable thermal images (e.g., thermograms) using appropriate methods and algorithms. For example, as described above with respect to processor 1204 of FIG. 12, the thermographic data contained in the thermal images may be converted into gray-scaled or color-scaled pixels to construct images that can be viewed by a person. User-viewable thermal images may optionally include a legend or scale that indicates the approximate temperature of corresponding pixel color and/or intensity. Such user-viewable thermal images, if presented on a display (e.g., display 1208/1408), may be useful to a user (e.g., a driver or a technician) in confirming or better understanding the abnormal conditions detected through process 1500, or in visually detecting conditions not otherwise detected through process 1500.

At block 1530, monitoring information may be generated by collecting, compiling, analyzing, or otherwise managing the various alarms and data from the various thermal image analytics and profiling operations described above. In one embodiment, the monitoring information may include one or more alarms based on the various abnormal conditions detected, one or more descriptions of the detected abnormal conditions (e.g., the location and the classification of the detected abnormal condition), one or more temperature readings of one or more vehicle components, one or more user-viewable thermal images of the relevant vehicle components, and/or other data and alarms. Thus, the monitoring information may include comprehensive data and warnings regarding the condition of the various vehicle components, and as such, may beneficially permit users (e.g., drivers) to avoid costly damages and save lives.

At block 1532, the context information, the generated monitoring information, and/or other acquired or generated data may be stored (e.g., in memory 1206). The stored information and data can be retrieved or recalled later by a user (e.g., a mechanic or a driver) for purposes of reviewing and further diagnosing the condition of the various vehicle components being monitored.

In one embodiment, a trending analysis may be performed on the monitoring information and other related data acquired and/or generated over a certain period. Such an analysis may produce a summarized view of various conditions of the wheel assembly components. Such a trending summary may be updated and/or stored at block 1532, and retrieved later by a user, for example, to use as a guide in properly aligning various suspension components and properly adjusting brake ducting.

In one example, the trending summary may include an averaged image of the user-viewable thermal images of the wheel assembly components. In another example, the stored trending summary may include correlation data between the monitoring information and some or all of the context information (e.g., an accelerometer reading, a wheel speed reading, a vehicle suspension mode set to “sport” or “comfort”). Such correlation data may be used to reveal the effects of various factors on the wheel assembly components. For example, a user may selectively review a summary of monitoring information based on whether the vehicle was driven with a suspension control system set to a “sport mode” or a “comfort mode.”

In some embodiments, the monitoring information, the trending summary, and/or other related data may be provided to a conventional on-board data recording device for storage. For example, many race cars are equipped with an on-board data acquisition and recording device. The monitoring information may be synchronized and stored along with other race related data (e.g., lap time, track position) in such a device for a real-time and post-race analysis. In a more specific example, a race data recording device may have a plurality of video ports for storing a plurality of video streams synchronized with various other race data. A stream of user-viewable thermal images (e.g., user-viewable thermal images generated at block 1528) may be fed into one of these video ports for synchronized storage. The stream of user-viewable thermal images may even be tiled, stitched, or otherwise combined to simultaneously show different wheel assemblies or different parts of wheel assemblies (e.g., four streams tiled to show user-viewable thermal images of all four wheel assemblies in one stream).

At block 1534, one or more vehicle components may be adjusted based on the monitoring information. In one embodiment, various suspension components may automatically be adjusted by a processor (e.g., processor 1204) generating signals to control actuators and motors (e.g., drive mechanisms 1214) attached to various suspension links and joints, if monitoring information indicates a suspension misalignment. In one embodiment, a tire may automatically be inflated by a processor activating an on-board pump, if monitoring information indicates an underinflation. In other embodiments, a user (e.g., a mechanic) may adjust suspension alignment and/or tire pressure based on the stored monitoring information and/or the trend summary, as described above for block 1532. Such automatic and/or manual adjustments based on the comprehensive and real-time monitoring information allow the various wheel assembly components to maintain appropriate working temperature and thereby achieve optimal traction and/or braking efficiency.

At block 1536, the monitoring information may be presented, for example, on display 1208/1408 for viewing by a driver, other occupants of a vehicle, a mechanic, or other appropriate users. In one embodiment, the monitoring information may be presented on a display (e.g., display 1408) onboard a vehicle, so that a driver or any other occupant may be informed of any dangerous and/or costly condition of various vehicle components in real time while the vehicle is being driven.

Therefore, it will be appreciated that process 1500 permits on-board and real-time detection and warning of various wheel assembly-related abnormal conditions that cannot be detected using conventional sensors (e.g., temperature sensors, tire pressure sensors) and/or cannot be identified without an inspection by an expert or other persons while the vehicle is stationary. It is also contemplated that process 1500 may be adapted or modified for monitoring of various other vehicle components in addition to wheel assembly components.

Where applicable, various embodiments provided by the present disclosure can be implemented using hardware, software, or combinations of hardware and software. Also where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as non-transitory instructions, program code, and/or data, can be stored on one or more non-transitory machine readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the invention. Accordingly, the scope of the invention is defined only by the following claims.

What is claimed is:

1. A vehicle comprising:
a wheel assembly;
an infrared imaging module comprising a focal plane array (FPA) configured to capture a thermal image of at least a portion the wheel assembly; and
a processor in communication with the infrared imaging module and configured to process the thermal image to generate monitoring information associated with the wheel assembly.

2. The vehicle of claim 1, further comprising a display configured to present the monitoring information to a user, and wherein the processor is configured to communicate wirelessly with the infrared imaging module.

3. The vehicle of claim 1, wherein:
the processor is configured to determine a temperature of at least a portion of the wheel assembly from the thermal image, and to detect whether the temperature is abnormal; and
the monitoring information comprises an alarm based on the detection of the temperature abnormality.

4. The vehicle of claim 1, wherein:
the wheel assembly comprises a tire;
the thermal image includes an image of thermal radiation from the tire;
the processor is configured to analyze the thermal image to detect an abnormal condition associated with the wheel assembly; and
the monitoring information comprises an alarm based on the detected abnormal condition.

5. The vehicle of claim 4, wherein:
the detected abnormal condition is a flat tire condition, a tire tread separation condition, a tire air leak condition, an underinflated tire condition, an overinflated tire condition, a suspension misalignment condition, an unbalanced wheel condition, a worn suspension condition, or a worn tire condition; and
the monitoring information comprises an identification of the detected abnormal condition.

6. The vehicle of claim 1, wherein:
the wheel assembly comprises a brake assembly;
the thermal image includes an image of thermal radiation from the brake assembly;
the processor is configured to analyze the thermal image to detect an abnormal condition associated with the brake assembly; and
the monitoring information comprises an alarm based on the detected abnormal condition.

7. The vehicle of claim 6, wherein:
the abnormal condition is a crack formation condition, a brake glazing condition, a high spot formation condition, or a brake warping condition; and
the monitoring information comprises an identification of the detected abnormal condition.

8. The vehicle of claim 1, wherein:
the processor is configured to convert the thermal image into a user-viewable image of the at least a portion of the wheel assembly; and
the monitoring information comprises the user-viewable image of the at least a portion of the wheel assembly.

9. The vehicle of claim 1, wherein:
the thermal image is an unblurred thermal image of the at least a portion of the wheel assembly;
the infrared imaging module is configured to capture an intentionally blurred thermal image of the at least a portion of the wheel assembly; and
the processor is configured to determine a plurality of non-uniform correction (NUC) terms based on the intentionally blurred thermal image and apply the NUC terms to the unblurred thermal image to remove noise form the unblurred thermal image.

10. The vehicle of claim 1, wherein:
the processor is configured to store the monitoring information in a memory device or a recording device; and
the processor is configured to generate, based on the monitoring information, a control signal to adjust one or more vehicle components associated with the wheel assembly.

11. A method comprising:
capturing, at a focal plane array (FPA) of an infrared imaging module, a thermal image of at least a portion of a wheel assembly of a vehicle, wherein the infrared imaging module is mounted in or on the vehicle so that the at least a portion of the wheel assembly is within its field of view (FOV);
processing the thermal image to determine a condition of the wheel assembly; and
generating monitoring information about the condition of the wheel assembly.

12. The method of claim 11, wherein the processing is by a processor, the method further comprising:
receiving the thermal image at the processor via wireless communication; and
presenting the monitoring information to a user.

13. The method of claim 11, wherein:
the processing comprises determining a temperature of at least a portion of the wheel assembly from the thermal image, and detecting whether the temperature is abnormal; and
the monitoring information comprises an alarm based on the detection of the temperature abnormality.

14. The method of claim 11, wherein:
the thermal image includes an image of thermal radiation from a tire;
the processing comprises analyzing the thermal image to detect an abnormal condition associated with the wheel assembly; and
the monitoring information comprises an alarm based on the detected abnormal condition.

15. The method of claim 14, wherein:
the detected abnormal condition is a flat tire condition, a tire tread separation condition, a tire air leak condition, an underinflated tire condition, an overinflated tire condition, a suspension misalignment condition, an unbalanced wheel condition, a worn suspension condition, or a worn tire condition; and
the monitoring information comprises an identification of the detected abnormal condition.

16. The method of claim 11, wherein:
the thermal image includes an image of thermal radiation from a brake assembly;
the processing comprises analyzing the thermal image to detect an abnormal condition associated with the brake assembly; and
the monitoring information comprises an alarm based on the detected abnormal condition.

17. The method of claim 16, wherein:
the abnormal condition is a crack formation condition, a brake glazing condition, a high spot formation condition, or a brake warping condition; and
the monitoring information comprises an identification of the detected abnormal condition.

18. The method of claim 11, further comprising:
converting the thermal image into a user-viewable image of the at least a portion of the wheel assembly, wherein the monitoring information comprises the user-viewable image of the at least a portion of the wheel assembly.

19. The method of claim 11, wherein the thermal image is an unblurred thermal image, the method further comprising:
capturing an intentionally blurred thermal image of the at least a portion of the wheel assembly;
determining a plurality of non-uniform correction (NUC) terms based on the intentionally blurred thermal image; and
applying the NUC terms to the unblurred thermal image to remove noise from the unblurred thermal image.

20. The method of claim 11, further comprising:
storing the monitoring information in a memory device or a recording device; and
generating, based on the monitoring information, a control signal to adjust one or more vehicle components associated with the wheel assembly.
